(19) United States
(12) Patent Application Publication
(10) Pub. No.: US 2025/0137303 A1
(43) Pub. Date: May 1, 2025

(54) OUTER HANDLE DEVICE FOR VEHICLE DOOR

(71) Applicant: Minebea AccessSolutions Inc., Miyazaki-shi (JP)

(72) Inventor: Yuki YAMAMURA, Miyazaki-shi (JP)

(21) Appl. No.: 18/925,217

(22) Filed: Oct. 24, 2024

(30) Foreign Application Priority Data
Oct. 28, 2023 (JP) 2023-185124

(51) Int. Cl. E05B 85/10; E05B 85/16

(52) U.S. Cl. CPC E05B 85/107; E05B 85/16

(57) ABSTRACT

A light reflecting surface is provided at least part of a rear surface of an end portion of at least on a vehicle rear side, among exposed surfaces of an outer handle that are exposed to an outside in the pop-up position.

### TECHNICAL FIELD

The present invention relates to an outer handle device for a vehicle door, and in particular to an outer handle device in which an outer handle including a manually operable operating portion is attached to a support case fixed to an outer panel of the door so as to be movable between a housed position in which an outer surface of the outer handle is substantially flush with an outer surface of the outer panel and a pop-up position in which the operating portion protrudes outward from the outer panel, an actuator is provided that can drive the outer handle from the housed position to the pop-up position, and the outer handle is attached to the support case so as to be fully stroked manually from the pop-up position to a full stroke position further outward.

### BACKGROUND ART

The outer handle devices described above are well known (see, for example, JP 2001-40913 A and JP 6629724 B). These devices are useful in preventing tampering and theft because the outer handle is normally placed in a housed state in which the outer handle is substantially flush with the outer panel (i.e., the outer handle does not protrude outward from the outer panel).

### SUMMARY

However, in the well known devices disclosed in JP 2001-40913 A and JP 6629724 B described above, the outer handle protrudes outward from the outer surface of the outer panel to some extent when the outer handle is in the pop-up position. Therefore, in situations where visibility is reduced, such as at night, there is a concern that people, vehicle drivers, or the like moving around the outside door may not notice the outer handle in the pop-up position and the people or the vehicles may come into contact with the outer handle.

The present invention has been made in view of such circumstances, and an object thereof is to provide an outer handle device for a vehicle door that can effectively avoid the contact with a simple structure.

In order to achieve the above object, according to a first aspect of the present invention, an outer handle device for a vehicle door includes: an outer handle including an operating portion configured to be manually operated, and being attached to a support case fixed to an outer panel of a door so as to be movable between a housed position where an outer surface of the outer handle is substantially flush with an outer surface of the outer panel and a pop-up position where the operating portion protrudes outward from the outer panel; and an actuator configured to drive the outer handle from the housed position to the pop-up position. The outer handle is attached to the support case so that the outer handle can be fully stroked manually from the pop-up position to a full stroke position further outward, and a light reflecting surface is provided at at least part of a rear surface of an end portion of at least on a vehicle rear side, among exposed surfaces of the outer handle that are exposed to an outside in the pop-up position.

Further, according to a second aspect of the present invention, an outer handle device for a vehicle door includes: an outer handle including an operating portion configured to be manually operated, and being attached to a support case fixed to an outer panel of a door so as to be movable between a housed position where an outer surface of the outer handle is substantially flush with an outer surface of the outer panel and a pop-up position where the operating portion protrudes outward from the outer panel; and an actuator configured to drive the outer handle from the housed position to the pop-up position. The outer handle is attached to the support case so that the outer handle can be fully stroked manually from the pop-up position to a full stroke position further outward, and a light reflecting surface is provided at at least part of an upper surface, of the outer handle, that is exposed to an outside in the pop-up position.

According to the first aspect of the present invention, the light reflecting surface is provided at at least part of the rear surface of the end portion on at least the vehicle rear side, among the exposed surfaces of the outer handle that are exposed to the outside in the pop-up position. Therefore, even when the outer handle protrudes outward from the outer surface of the outer panel to some extent in the pop-up position, people, vehicle drivers, or the like moving around the outside door in situations where visibility is reduced, such as at night, can easily notice the presence of the outer handle in the pop-up position by the reflected light from the light reflecting surface on the rear surface of the outer handle, and thus contact with the outer handle can be effectively avoided.

According to the second aspect, the light reflecting surface is provided at at least part of the upper surface, of the outer handle, that is exposed to the outside in the pop-up position. Therefore, even when the outer handle protrudes outward from the outer surface of the outer panel to some extent in the pop-up position, people, vehicle drivers, or the like moving around the outside door, in situations where visibility is reduced, such as at night, can easily notice the presence of the outer handle in the pop-up position by the reflected light from the light reflecting surface on the upper surface of the outer handle, and thus contact with the outer handle can be effectively avoided.

According to a third aspect, on the upper surface, of the outer handle, that is exposed to the outside in the pop-up position, a cover configured to cover at least part of the upper surface is detachably attached. Therefore, for example, the cover may be colored differently from a paint color of the outer surface of the outer handle or plated to provide variety, and the cover can be replaced easily to suit a preference of the user. Moreover, since the light reflecting surface is provided at at least the rear surface of the cover, the variety of the light reflecting surface to be provided at the outer handle can be increased easily and at low cost.

According to a fourth aspect, a pivot shaft configured to guide and support a pivotal movement of the outer handle is fitted with the outer handle when the outer handle is pivotally operated from the pop-up position to the full stroke position, and the cover is provided with an engagement portion configured to engage with the pivot shaft to prevent the pivot shaft from coming off the outer handle. Therefore, the cover can also be used as a means for preventing the pivot shaft that guides and supports the pivotal movement of the outer handle from coming off the outer handle, thereby simplifying a structure and contributing to cost reduction.

According to a fifth aspect, the outer handle is provided with an LED that illuminates the light reflecting surface, thereby further improving the visibility of the light reflecting surface.

### BRIEF DESCRIPTION OF DRAWINGS

FIG. 1A is a side view illustrating main parts of a door in a state in which an outer handle is in a housed position;

FIG. 1B is a side view illustrating main parts of a door in a state in which an outer handle is in a pop-up position;

FIG. 1C is a side view illustrating main parts of a door in a state in which an outer handle is in a full stroke position according to a first embodiment;

FIG. 2 is a cross-sectional view taken along a line 2-2 in FIG. 1A;

FIG. 3 is an exploded perspective view of parts illustrated in FIG. 2.

FIG. 4 is a view seen from an arrow 4 in FIG. 2 for illustrating a drive lever that is in an initial position, without illustrating a cover member;

FIG. 5 is a view corresponding to FIG. 4 in a state in which the drive lever has pivoted to an operating position;

FIG. 6 is a view corresponding to FIG. 3 in a state in which the outer handle has pivotally operated to a full stroke position;

FIG. 7 is a cross-sectional view taken along a line 7-7 in FIG. 4;

FIG. 8 is a cross-sectional view taken along a line 8-8 in FIG. 4;

FIG. 9 is an enlarged perspective view corresponding to FIG. 1A, illustrating an installation site of a light reflecting surface provided at the outer handle in the pop-up position;

FIG. 10 is an enlarged plan view (a plan view seen from an arrow 10 in FIG. 9) illustrating an installation site of the light reflecting surface provided at the outer handle in the pop-up position;

FIG. 11 is a view illustrating a modified example of the first embodiment and corresponding to FIG. 3 in a state in which the drive lever is in the initial position;

FIG. 12 is a view corresponding to FIG. 11 in a state in which the drive lever has pivoted to the operating position;

FIG. 13 is a vertical cross-sectional view of a retention means, viewed from a support case side;

FIG. 14 is a view corresponding to FIG. 11 in a state in which the outer handle has pivotally operated to the full stroke position;

FIG. 15A is a side view of main parts of a door according to a second embodiment, illustrating a state in which an outer handle is in a housed position;

FIG. 15B is side a view of main parts of the door according to the second embodiment illustrating a state in which the handle is in a pop-up position;

FIG. 15C is side view of main parts of the door according to the second embodiment, illustrating a state in which the handle is in a full stroke position;

FIG. 16 is a plan view illustrating main parts of the outer handle according to the second embodiment, without illustrating a light reflecting surface;

FIG. 17A is a longitudinal plan view illustrating movements of parts of a drive device D and a guide device G of the outer handle when the outer handle of the second embodiment is in the housed position;

FIG. 17B is a longitudinal plan view illustrating movements of parts of the drive device D and the guide device G of the outer handle when the outer handle of the second embodiment is in the pop-up position;

FIG. 17C is a longitudinal plan view illustrating movements of parts of the drive device D and the guide device G of the outer handle when the outer handle of the second embodiment is in the full stroke position.

FIG. 18 is an enlarged cross-sectional view of main parts in FIG. 17B.

FIG. 19A is a perspective view of a transmission frame 170 alone, which is a main part of an interlocking mechanism I, as viewed obliquely from above;

FIG. 19B is a perspective view of a second arm A2 alone, as viewed obliquely from above.

FIG. 20A is an exploded perspective view illustrating main parts of a front portion of the outer handle;

FIG. 20B is a cross-sectional view taken along a line b-b in FIG. 20A;

FIG. 20C is a cross-sectional view taken along a line c-c in FIG. 20A.

FIG. 21 is an enlarged perspective view of a cross-section taken along a line 21-21 in FIG. 18, as viewed obliquely from above; and

FIG. 22 is an exploded perspective view illustrating main parts of a rear portion of the outer handle.

### DETAILED DESCRIPTION

Hereinafter, embodiments of the present invention will be described with reference to the accompanying drawings.

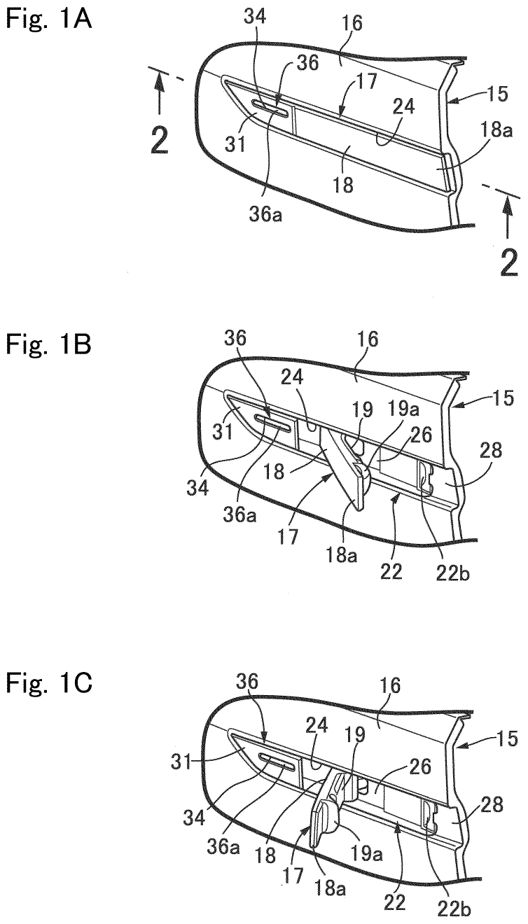

First, a first embodiment will be described with reference to FIGS. 1A to 10. In FIGS. 1A to 1C, an outer panel 16 of a side door 15 for a passenger vehicle is provided with an outer handle 17 which is formed long in a vehicle longitudinal direction. The outer handle 17 can be changed in position between a housed position where an outer surface of the outer panel 16 is flush with an outer surface of the outer handle 17, as illustrated in FIG. 1A, a pop-up position where an operating portion 18a at one end of the outer handle 17 protrudes laterally from the outer surface of the outer panel 16, as illustrated in FIG. 1B, and a full stroke position where the outer handle 17 is pivoted further outward from the pop-up position by grasping and operating the operating portion 18a, as illustrated in FIG. 1C.

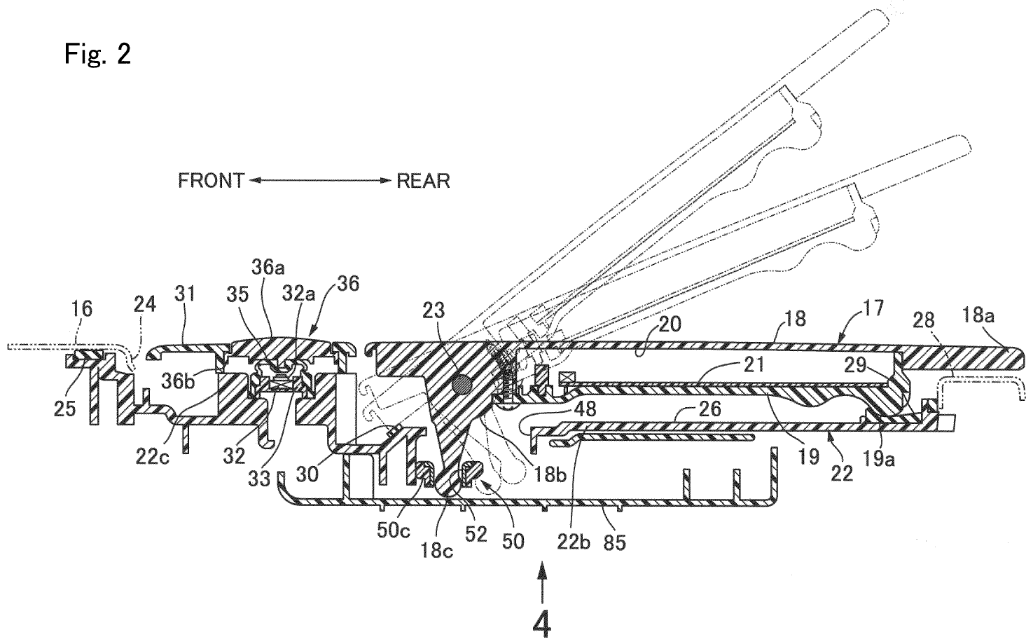

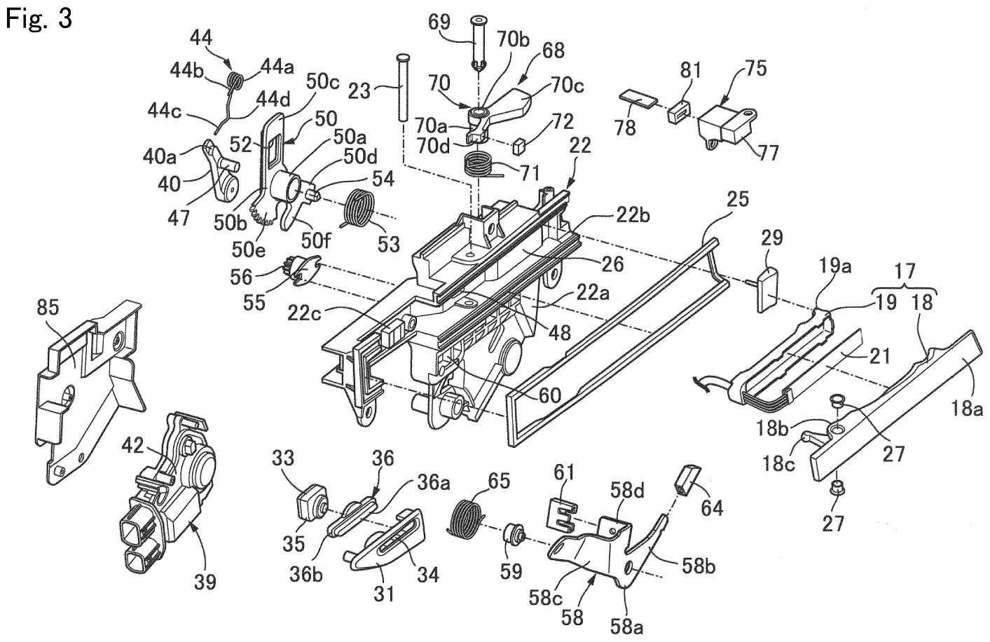

Referring to FIGS. 2 and 3 together, the outer handle 17 is composed of a handle body 18 that has a recessed portion 20 facing an inner side of the outer panel 16, extends long in the vehicle longitudinal direction, and includes the operating portion 18a at one end (a rear end in the illustrated example), and a handle base 19 that is fastened to the handle body 18 from the outer panel 16 side so as to close the recessed portion 20, and a substrate 21 on which electronic components such as a touch sensor and an antenna are mounted is attached to an inner surface of the handle base 19.

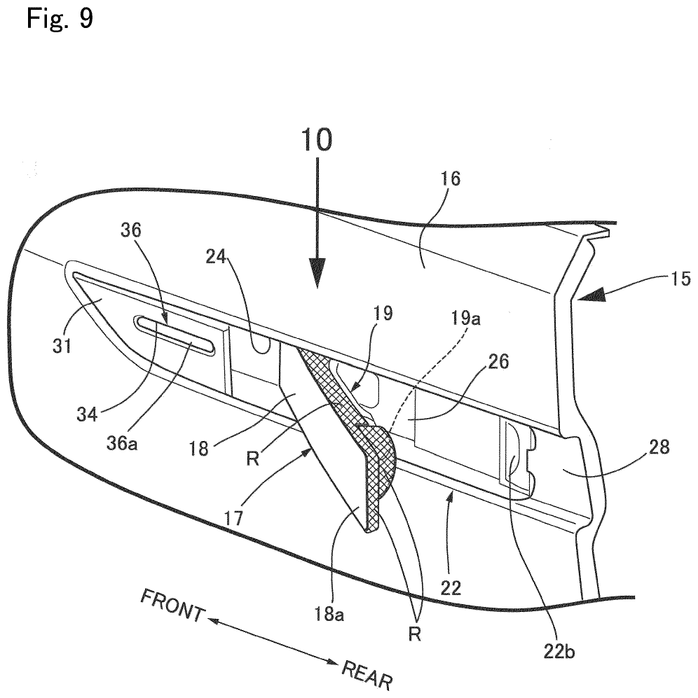

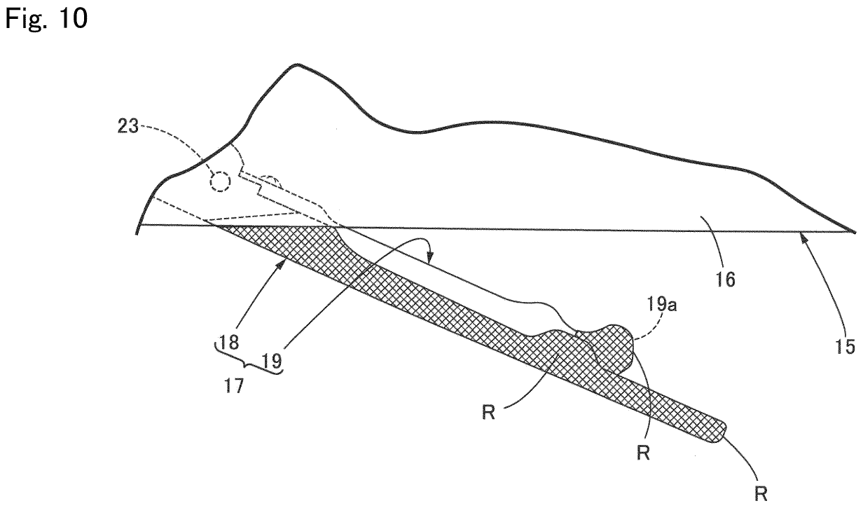

As is apparent from FIGS. 9 and 10, an upper surface and a rear surface (i.e., a surface facing the vehicle rear side) of the outer handle 17 that are exposed to the outside in the pop-up position are provided with a light reflecting surface R (indicated by cross-hatching in FIGS. 9 and 10 in order to make a reflective surface area clearer) that shines by reflecting external light (e.g., lights of other vehicles, street lights, etc.).

The light reflecting surface R can be provided at the upper surface and the rear surface of the outer handle 17 (to be more specific, the handle body 18 and the handle base 19) that are exposed to the outside in the pop-up position and the full stroke position, for example, by attaching a light reflecting sheet or a light reflecting tape to the upper surface and the rear surface, or by painting the upper surface and the rear surface with a light reflecting paint.

Thus, in the embodiment, the light reflecting surface R is provided at at least part of a rear surface of the end portion at least on the vehicle rear side and the upper surface (the entire surface in the illustrated example), among the exposed surfaces of the outer handle 17 that are exposed to the outside in the pop-up position. Thus, even when the outer handle 17 protrudes outward from the outer surface of the outer panel 16 to some extent in the pop-up position, people, vehicle drivers, or the like moving around the side door 15 in situations where visibility is reduced, such as at night, can easily notice the presence of the outer handle 117 in the pop-up position by the reflected light from the light reflecting surface R, and thus contact with the outer handle 17 can be effectively avoided.

The outer handle 17 is pivotally supported via a support shaft 23 by a support case 22 fixed to the outer panel 16. The outer panel 16 is provided with an opening 24 that extends long in the vehicle longitudinal direction. The support case 22 includes a support plate portion 22a that faces an inner surface of the outer panel 16 and a handle support portion 22b that is integrally provided at an upper portion of the support plate portion 22a and extends in the vehicle longitudinal direction so as to close the opening 24 from the inner side of the outer panel 16, and is fastened to the inner surface side of the outer panel 16. A sealing member 25 that seals a peripheral edge portion of the opening 24 is interposed between the support case 22 and the outer panel 16.

The handle support portion 22b of the support case 22 is formed with a housing recessed portion 26 extending long in the vehicle longitudinal direction corresponding to the opening 24 so as to be recessed inwardly of the outer panel 16. Most of the outer handle 17 excluding the operating portion 18a is housed in the housing recessed portion 26 when the outer handle 17 is in the housed position where the outer handle 17 is flush with the outer surface of the outer panel 16.

The support shaft 23 is attached to the handle support portion 22b of the support case 22 so as to cross the housing recessed portion 26 in the vertical direction, and the support shaft 23 is inserted through a pair of short cylindrical collars 27 and 27 into a support portion 18b that is provided integrally with the handle body 18 near the other end of the outer handle 17 and disposed in the housing recessed portion 26. The outer panel 16 is provided with a recessed portion 28 that is continuous with the opening 24 and that houses the operating portion 18a of the outer handle 17 when the outer handle 17 is in the housed position.

A first elastic member 29 is attached to the handle support portion 22b of the support case 22 so as to be positioned in the housing recessed portion 26 and to abut against a thick abutment protrusion portion 19a that is provided integrally with the handle base 19 in proximity to the operating portion 18a when the outer handle 17 is in the housed position, and a second elastic member 30 (see FIG. 2) that abuts against the other end portion of the handle body 18 of the outer handle 17 in the full stroke position is attached so as to be positioned in the housing recessed portion 26.

The remaining portion of the housing recessed portion 26, excluding the portion that houses most of the outer handle 17 in the housed position, is closed by a base cover 31 that is attached to the support case 22 adjacent to the other end portion of the outer handle 17 in the housed position, and a switch support portion 22c that protrudes into the housing recessed portion 26 is integrally provided at the handle support portion 22b of the support case 22 at a position corresponding to the base cover 31.

Paying attention to FIG. 2, a switch holder 33 that holds a tact switch 32 that is turned on and off by a vehicle user's operation to indicate an intention to lock the side door 15 is supported on the switch support portion 22c.

On the other hand, a rectangular window 34 extending long in the vehicle longitudinal direction is provided at the base cover 31 at a portion corresponding to the switch support portion 22c. An intermediate cap 35 made of an elastic material that enables a pressing force to act on a pressed portion 32a of the tact switch 32 is attached to the switch holder 33 so as to cover the tact switch 32. A switch button 36 made of a hard synthetic resin and including a rectangular pressing operating portion 36a that is disposed at the window 34 is connected to the intermediate cap 35, and a flange portion 36b that abuts against an inner surface of the base cover 31 around the window 34 is formed integrally with the switch button 36. Moreover, a resilient force exerted by the intermediate cap 35 biases the switch button 36 toward the non-operating position in which the flange portion 36b abuts against the inner surface of the base cover 31.

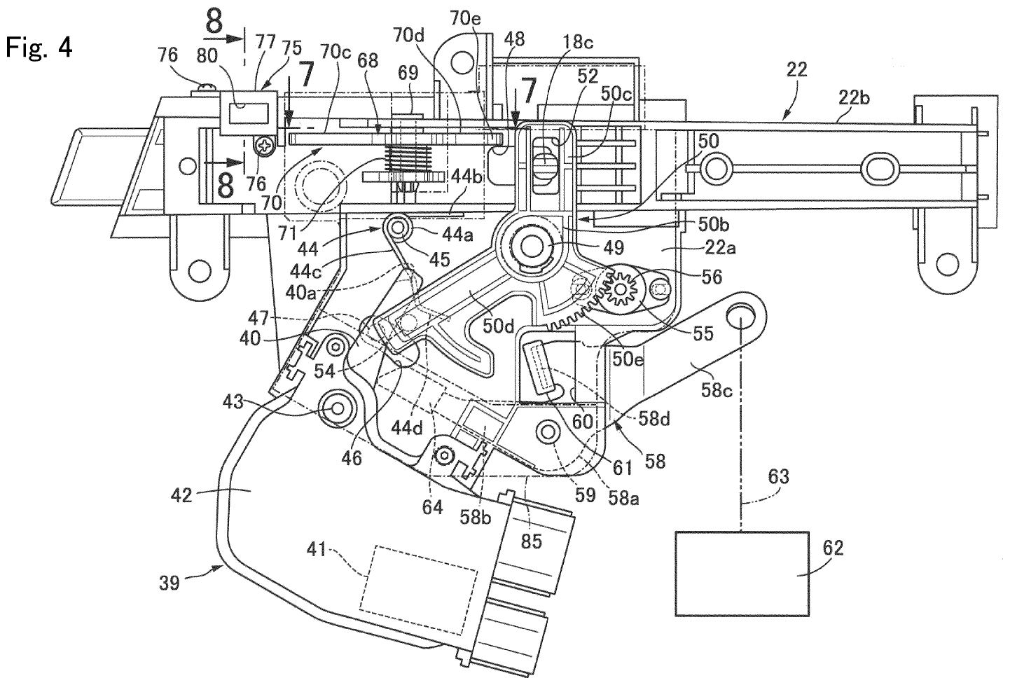

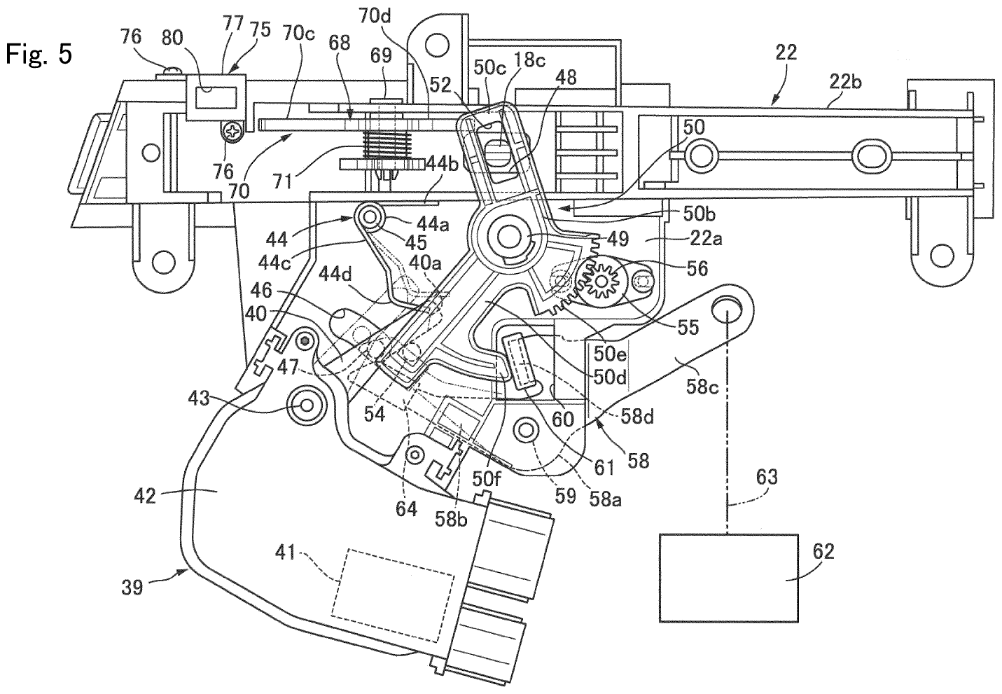

Referring to FIGS. 4 and 5 together, an actuator 39 is attached to the support plate portion 22a of the support case 22. The actuator 39 enables the outer handle 17, which is in the housed position and housed on the support case 22 side, to be driven to the pop-up position where the operating portion 18a protrudes outward from the outer panel 16. The actuator 39 is configured to include a drive lever 40 that is pivotal between an initial position illustrated in FIG. 4 and an operating position illustrated in FIG. 5, and an electric motor 41 as an electric drive source that pivotally drives the drive lever 40 from the initial position to the operating position when energized, and allows the drive lever 40 to return from the operating position to the initial position in a non-energized state when the drive lever 40 is in the operating position.

An actuator case 42 that houses the electric motor 41 is attached to a lower portion of the support plate portion 22a of the support case 22 so as to protrude downward from the support plate portion 22a. One end portion of the drive lever 40 is fixed to a pivot shaft 43 that is pivotally supported on an upper portion of the actuator case 42, and a transmission mechanism (not illustrated) provided between the electric motor 41 and the pivot shaft 43 is housed in the actuator case 42.

The support plate portion 22a of the support case 22 is provided with a retention means for mechanically holding the drive lever 40 in the operating position. In this embodiment, the retention means is a torsion spring 44. A cylindrical spring support portion 45 is protrudingly provided at the support plate portion 22a of the support case 22 so as to be disposed above the drive lever 40 and below the handle support portion 22b, and the torsion spring 44 includes a coil portion 44a surrounding the spring support portion 45 and first and second arm portions 44b and 44c extending from both ends of the coil portion 44a.

The first arm portion 44b of the torsion spring 44 abuts against and engages with the handle support portion 22b located above the spring support portion 45 from below. The second arm portion 44c is disposed so as to extend from the spring support portion 45 toward the drive lever 40, and a bent peak portion 44d is formed at an intermediate portion of the second arm portion 44c so as to protrude toward the drive lever 40.

On the other hand, a surface of the drive lever 40 facing the support plate portion 22a is integrally provided with an abutment step portion 40a formed in a peak shape so as to abut against the second arm portion 44c from below. When the drive lever 40 is in the initial position, a portion of the second arm portion 44c closer to the spring support portion 45 than the peak portion 44d resiliently abuts against the abutment step portion 40a from above. When the drive lever 40 pivots from the initial position, through an intermediate position illustrated by a chain line in FIG. 5, to the operating position illustrated by a solid line in FIG. 5, the abutment step portion 40a rides over the peak portion 44d while pushing the second arm portion 44c upward. When the drive lever 40 has pivoted to the operating position, the drive lever 40 is mechanically held in the operating position by the peak portion 44d of the torsion spring 44 unless an external force is applied to the drive lever 40.

The support plate portion 22a of the support case 22 is formed with a guide hole 46 having an arc-shape centered on an axis of the pivot shaft 43, and a pin 47 that passes through the guide hole 46 is planted in the drive lever 40. The guide hole 46 is formed so as to allow the pin 47 to move with a pivotal movement of the drive lever 40 between the initial position and the operating position.

The handle body 18 of the outer handle 17 is integrally provided with a coupling protruding portion 18c that is connected to the support portion 18b, the coupling protruding portion 18c passes through a long hole 48 that is provided at the handle support portion 22b of the support case 22 and extends long in the vehicle longitudinal direction, and a tip portion of the coupling protruding portion 18c protrudes inward through the handle support portion 22b of the support case 22.

The support plate portion 22a of the support case 22 is integrally provided with a cylindrical lever support portion 49 that is disposed below the handle support portion 22b at a portion corresponding to the long hole 48, and a handle lever 50 is pivotally supported on the lever support portion 49.

The handle lever 50 integrally includes a first lever base portion 50b provided with a cylindrical first support cylinder portion 50a (see FIG. 3) pivotally supported by the lever support portion 49, an outer handle side coupling arm portion 50c extending upward from the first lever base portion 50b, a drive lever side coupling arm portion 50d extending obliquely downward from the first lever base portion 50b toward the drive lever 40, and a sector gear portion 50e protruding from the first lever base portion 50b in a direction opposite to the torsion spring 44.

A coupling hole 52 extending long in the longitudinal direction is formed at the outer handle side coupling arm portion 50c, and a tip portion of the coupling protruding portion 18c provided at the outer handle 17 is inserted and coupled to the coupling hole 52. That is, the handle lever 50 is interlocked and coupled to the outer handle 17, and the handle lever 50 is biased in a direction of returning the outer handle 17 to the housed position by a spring force of a first return spring 53 (see FIG. 3), which is a torsion spring surrounding the first support cylinder portion 50a and provided between the handle lever 50 and the support plate portion 22a.

An abutment pin 54 that abuts against the drive lever 40 in the initial position from the operating position side is implanted at a tip portion of the drive lever side coupling arm portion 50d so as to protrude toward the support plate portion 22a. By pushing the abutment pin 54 by the drive lever 40 in response to a pivotal movement of the drive lever 40 from the initial position to the operating position, the handle lever 50 pivots so as to drive the outer handle 17 from the housed position to the pop-up position.

Moreover, when the outer handle 17 pivots from the pop-up position to the full stroke position, the drive lever 40 is held by the torsion spring 44, so that the handle lever 50 pivots together with the outer handle 17, leaving the drive lever 40 in the operating position.

The sector gear portion 50e is meshed with a gear 56 included in a rotary damper 55 fastened to the support plate portion 22a. The rotary damper 55 functions to gently pivot the outer handle 17, which is biased in the direction returning to the housed position, to the housed position even when the outer handle 17 is released after the outer handle 17 is pivoted to the full stroke position.

A release lever 58 is pivotally supported by the support plate portion 22a of the support case 22. The release lever 58 pivots in response to a pivotal movement of the handle lever 50 accompanying manual operation of the outer handle 17 from the pop-up position to the full stroke position, to release retention of the drive lever 40 by the torsion spring 44 and forcibly return the drive lever 40 to the initial position.

The release lever 58 is disposed between the support plate portion 22a and the outer panel 16. The release lever 58 integrally includes a second lever base portion 58a that is pivotally supported by the support plate portion 22a via a first shaft 59 that is attached to the support plate portion 22a so as to be disposed below the handle lever 50, a drive lever side arm portion 58b that extends from the second lever base portion 58a toward the drive lever 40, and a latch mechanism side arm portion 58c that is connected to the second lever base portion 58a so as to form a substantially V shape together with the drive lever side arm portion 58b and protrudes from the support plate portion 22a toward a side opposite to an attachment portion of the actuator 39.

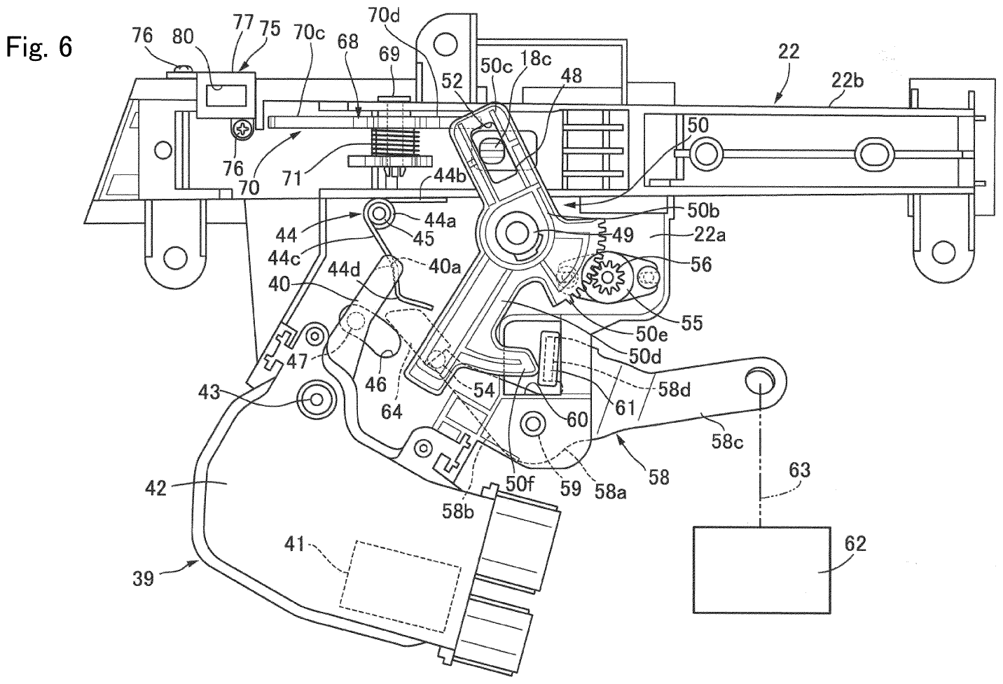

A rectangular through hole 60 disposed between the first lever base portion 50b of the handle lever 50 and the second lever base portion 58a of the release lever 58 is formed at the support plate portion 22a. A pressure receiving portion 58d, which is inserted into the through hole 60, is integrally provided at a right angle to an intermediate portion of the latch mechanism side arm portion 58b, and a handle side cap 61 made of an elastic material is attached to the pressure receiving portion 58d. On the other hand, a pushing arm portion 50f is integrally connected to the drive lever side coupling arm portion 50d of the handle lever 50. When the outer handle 17 pivots from the housed position to the pop-up position, the handle lever 50 pivots together with the outer handle 17, causing a tip portion of the pushing arm portion 50f to abut against the handle side cap 61. When the outer handle 17 pivots from the pop-up position to the full stroke position, the handle lever 50 pivots together with the outer handle 17, causing the pushing arm portion 50f to push the handle side cap 61, that is, the pressure receiving portion 58d, and causing the release lever 58 to pivot to the position illustrated in FIG. 6.

The side door 15 is provided with a latch mechanism 62 that can switch between a latched state in which the side door 15 is held closed by engaging with the vehicle body, and an unlatched state in which the side door 15 can be opened. A pivotal movement of the release lever 58 is transmitted to the latch mechanism 62 via a transmission rod 63, one end of which is coupled to a tip portion of the drive lever side arm portion 58b.

The latch mechanism 62 is provided with an electric motor (not illustrated) that switches between an unlocked state in which a latched state can be released, and a locked state in which the latched state cannot be released. The latch mechanism 62 is unlocked in response to detection by the touch sensor in the outer handle 17 that an authorized vehicle user has grasped the outer handle 17 in the locked state.

Upon being in the unlocked state, the latch mechanism 62 is unlatched by the force transmitted from the release lever 58 via the transmission rod 63 in response to pivoting the outer handle 17 from the pop-up position to the full stroke position, and the side door 15 can be opened in this state.

On the other hand, the electric motor 41 of the actuator 39 pivotally drives the drive lever 40 from the initial position to the operating position when an electronic control device (a substrate 121b described later) confirms that the vehicle user, who is within a predetermined range of the vehicle, is an authorized user through communication between the vehicle and a portable device carried by the vehicle user. The vehicle user can then grasp the outer handle 17, which has been moved to the pop-up position in response to the pivotal movement of the drive lever 40, and pivotally operate the outer handle 17 toward the full stroke position, thereby opening the side door 15.

Note that the operation of the electric motor 41 of the actuator 39 may be started by operating the portable device, instead of the prior authentication through communication with the portable device. The electric motor 41 of the actuator 39 may be capable of rotating in both forward and reverse directions, and when the outer handle 17 has been in the pop-up position for a predetermined time or more, the electric motor 41 may be operated in the reverse direction so as to return the drive lever 40 from the operating position to the initial position in order to return the outer handle 17 to the housed position.

A drive lever side cap 64 made of an elastic material is attached to a tip portion of the drive lever side arm portion 58b of the release lever 58. The drive lever side cap 64 abuts against the pin 47 of the drive lever 40, which is inserted into the guide hole 46, when the drive lever 40 pivots from the initial position to the operating position. The pivotal movement of the release lever 58 in response to the pivotal movement of the outer handle 17 from the pop-up position to the full stroke position causes the pin 47, that is, the drive lever 40, to be pushed by the latch mechanism side arm portion 58c of the release lever 58. Thus, as illustrated in FIG. 6, the drive lever 40 is pivotally driven forcibly so that the abutment step portion 40a rides over the peak portion 44d of the second arm portion 44c while pushing the second arm portion 44c of the torsion spring 44 upward, and once the abutment step portion 40a has ridden over the peak portion 44d, the drive lever 40 returns to the initial position due to a resilient force acting from the peak portion 44d of the second arm portion 44c.

A second return spring 65 (see FIG. 3), which is a torsion spring surrounding the first shaft 59, is provided between the release lever 58 and the support plate portion 22a, and the release lever 58 is pivotally biased by a spring force of the second return spring 65 to a side where the handle side cap 61 abuts against the pushing arm portion 50f of the handle lever 50.

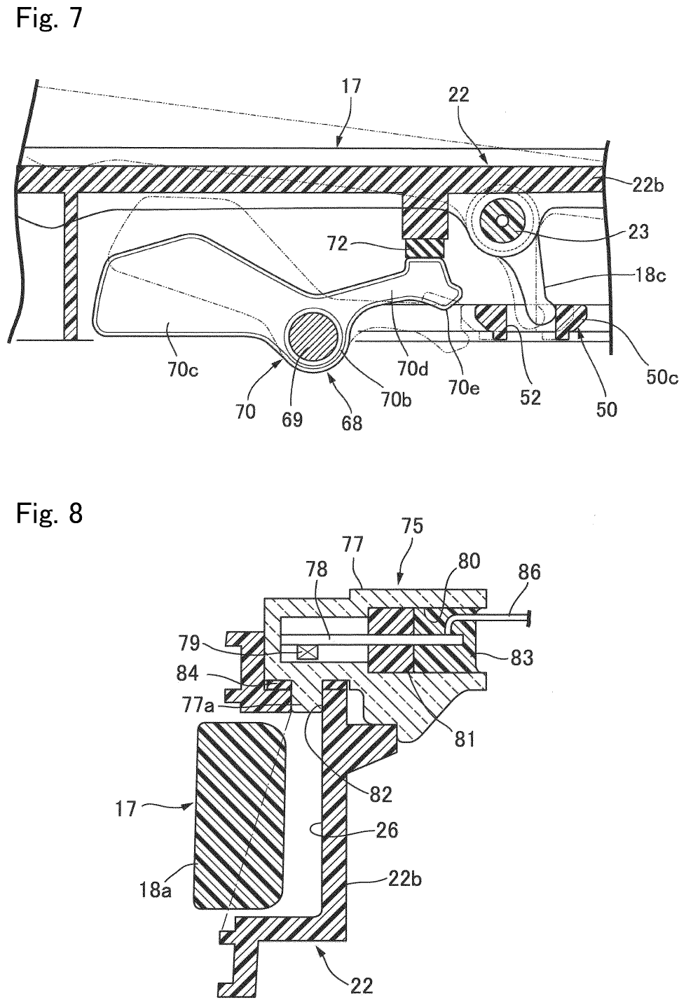

Referring also to FIG. 7, the handle support portion 22b of the support case 22 is provided with an inertia mechanism 68 that prevents the outer handle 17 from pivoting to the full stroke position due to an impact caused by a side collision with the side door 15 when the outer handle 17 is in the housed position, thereby preventing the side door 15 from opening undesirably.

The inertia mechanism 68 includes an inertia lever 70 that is pivotally supported by the handle support portion 22b via a second shaft 69 that is provided at the handle support portion 22b and has an axis parallel to the support shaft 23 pivotally supporting the outer handle 17 at the handle support portion 22b, and a third return spring 71 that is provided between the handle support portion 22b and the inertia lever 70.

The inertia lever 70 integrally includes a third lever base portion 70b provided with a cylindrical second support cylinder portion 70a that is pivotally supported by the second shaft 69, a weight arm portion 70c extending from the third lever base portion 70b to a side opposite to the handle side coupling arm portion 50c of the handle lever 50, and a restriction arm portion 70d extending from the third lever base portion 70b toward the handle side coupling arm portion 50c of the handle lever 50. When the inertia lever 70 pivots to a position that allows the outer handle 17 to pivot to the full stroke position (a state illustrated by the solid line in FIG. 7), a sponge 72 that abuts against a tip portion of the restriction arm portion 70d is affixed to the handle support portion 22b.

The third return spring 71 is a torsion spring that surrounds the second support cylinder portion 70a and is provided between the handle support portion 22b and the inertia lever 70, and the inertia lever 70 is pivotally biased by a spring force of the third return spring 71 in a direction in which the tip portion of the restriction arm portion 70d abuts against the sponge 72.

When the impact due to the side collision acts on the side door 15, the inertia lever 70 pivots to a position illustrated by a chain line in FIG. 7 faster than the pivotal movement of the handle lever 50 so as to separate the restriction arm portion 70d from the sponge 72, and when the handle lever 50 pivots together with the outer handle 17, the handle side coupling arm portion 50c of the handle lever 50 abuts against the tip portion of the restriction arm portion 70d as illustrated by a chain line in FIG. 7, thereby restricting the pivotal movement of the handle lever 50 and preventing the pivotal movement of the outer handle 17, which pivots together with the handle lever 50, towards the full stroke position.

The restriction arm portion 70d of the inertia lever 70 is formed with an abutment surface 70e against which the handle side coupling portion 50c of the handle lever 50 abuts in response to a pivotal operation of the outer handle 17 from the pop-up position to the full stroke position with the restriction arm portion 70d abutting against the sponge 72, and the abutment surface 70e is formed at an angle so as to obliquely intersect a moving direction of the handle side coupling portion 50c so that the inertia lever 70 can be pivoted in a direction in which the sponge 72 is compressed by the restriction arm portion 70d by a pressing force applied from the handle side coupling portion 50c. Thus, the inertia lever 70 pivots slightly each time the outer handle 17 is pivotally operated, preventing the inertia lever 70 from becoming stuck due to remaining stationary for a long period of time.

Note that as a preparation in case the inertia mechanism 68 fails to function, the rotary damper 55 may be used to absorb the impact in the event of a side collision and prevent the outer handle 17 from pivoting toward the full stroke position.

A light 75 that illuminates the operating portion 18a of the outer handle 17 positioned in the pop-up position is attached to the support case 22 or the outer handle 17, and in this embodiment, the light 75 that illuminates the operating portion 18a of the outer handle 17 positioned in the pop-up position is attached to the handle support portion 22b of the support case 22.

The light 75 includes a light case 77 made of a translucent synthetic resin and fastened to the handle support portion 22b by, for example, a pair of screw members 76 and 76, and a light emitting diode 79 provided at a substrate 78 inserted into and supported by the light case 77.

The light case 77 is formed in a box shape having an insertion hole 80 that is open on a side opposite to the outer panel 16, and the substrate 78 inserted into the insertion hole 80 is held by a grommet 81 that fits into the insertion hole 80. The light emitting diode 79 is provided at a lower surface of the substrate 78 at an end portion on the outer panel 16 side, and an opening end of the insertion hole 80 is filled with a potting material 83 for sealing a connection portion of a lead wire 86 to the substrate 78.

A through hole 82 that opens into the housing recessed portion 26 at a position corresponding to the operating portion 18a of the outer handle 17 is provided at an upper part of the handle support portion 22b so as to be located below the light emitting diode 79, a light guide portion 77a that guides light from the light emitting diode 79 is formed integrally with the light case 77 and is fitted into the through hole 82, and a sealing member 84 that endlessly surrounds the through hole 82 is interposed between the light case 77 and the handle support portion 22b.

A case cover 85 is attached to the support case 22 to cover part of the actuator 39, the torsion spring 44, the handle lever 50, the rotary damper 55, the inertia mechanism 68, and the like that are provided at the support case 22. The case cover 85 prevents the actuator 39, the torsion spring 44, the handle lever 50, the rotary damper 55, the inertia mechanism 68, and the like from being adversely affected by water or dust that has entered the side door 15 through a gap between the outer panel 16 and a window glass.

Next, the operation of the first embodiment will be described. The actuator 39 that enables the outer handle 17, which includes the manually operable operating portion 18a at one end portion, to be driven to the pop-up position in which the operating portion 18a protrudes outward from the outer panel 16 of the side door 15, is attached to the support case 22 that is attached to the outer panel 16. The actuator 39 is configured to include the drive lever 40 that is pivotal between the initial position and the operating position, and the electric motor 41 that, when energized, pivotally drives the drive lever 40 from the initial position to the operating position, and, in a non-energized state when the drive lever 40 is in the operating position, allows the drive lever 40 to return from the operating position to the initial position. The outer handle 17, which is housed in the support case 22 and pivotally biased toward the housed position, is supported by the support case 22 so as to be able to pivot to the full stroke position accompanying manual operation from the pop-up position, and the torsion spring 44 that mechanically holds the drive lever 40 in the operating position is attached to the support case 22. The handle lever 50 is pushed by the drive lever 40 to pivot in response to the pivotal movement of the drive lever 40 from the initial position to the operating position, and is interlocked and coupled to the outer handle 17 so as to pivot the outer handle 17 from the housed position to the pop-up position. The handle lever 50 is supported by the support case 22 so as to pivot together with the outer handle 17 when the outer handle 17 pivots from the pop-up position to the full stroke position, leaving the drive lever 40 in the operating position. The release lever 58 is supported on the support case 22. The release lever 58 pivots in response to the pivotal movement of the handle lever 50 accompanying manual operation of the outer handle 17 from the pop-up position to the full stroke position to release the retention by the retention means and forcibly return the drive lever 40 to the initial position.

Therefore, when the handle lever 50 is pivoted by the drive lever 40 of the actuator 39 and the outer handle 17 is pivoted from the housed position to the pop-up position, the drive lever 40 is held in the operating position by the torsion spring 44, and in this state, the pop-up position of the outer handle 17 is held even when the electric motor 41 of the actuator 39 is not energized. The electric motor 41 of the actuator 39 allows the drive lever 40, which is in the operating position, to return to the initial position by the action of an external force when the retention by the torsion spring 44 is released. When the vehicle user pivotally operates the outer handle 17 from the pop-up position to the full stroke position in order to open the side door 15, the handle lever 50, which pivots together with the outer handle 17, pivots the release lever 58. The release lever 58 releases the retention of the drive lever 40 by the torsion spring 44 and forcibly returns the drive lever 40 to the initial position. Therefore, even when the electric motor 41 of the actuator 39 malfunctions, the outer handle 17, which has been biased toward the housed position, can be returned to the housed position by releasing the hand from the outer handle 17. Therefore, even when the electric motor 41 of the actuator 39 malfunctions, the outer handle 17 can be returned to the housed position, and the power consumption for holding the outer handle 17 in the pop-up position can be reduced.

The light 75 that illuminates the operating portion 18a of the outer handle 17 positioned in the pop-up position is attached to the support case 22, so that the operating portion 18a of the outer handle 17 can be easily seen even in a dark state such as at night.

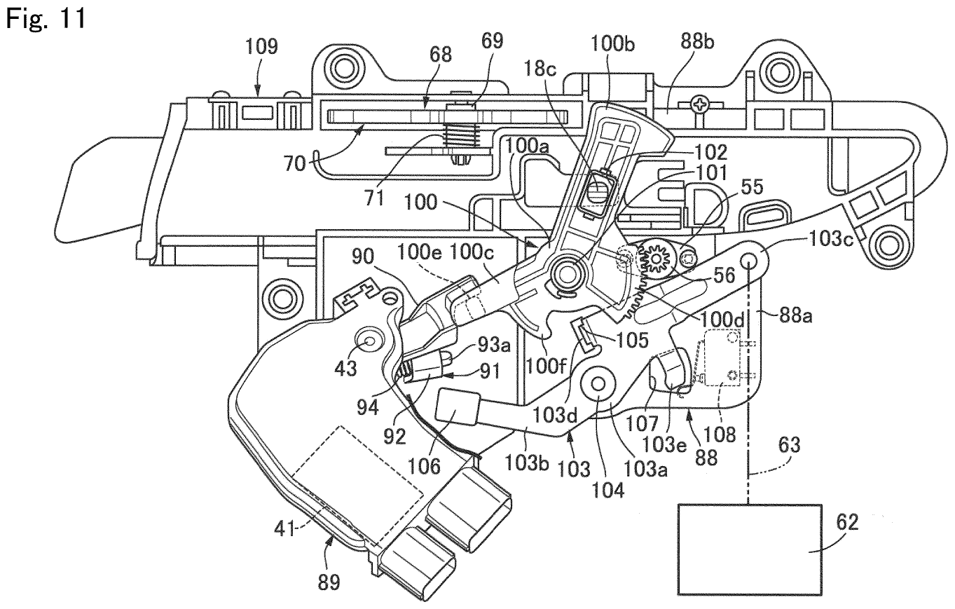

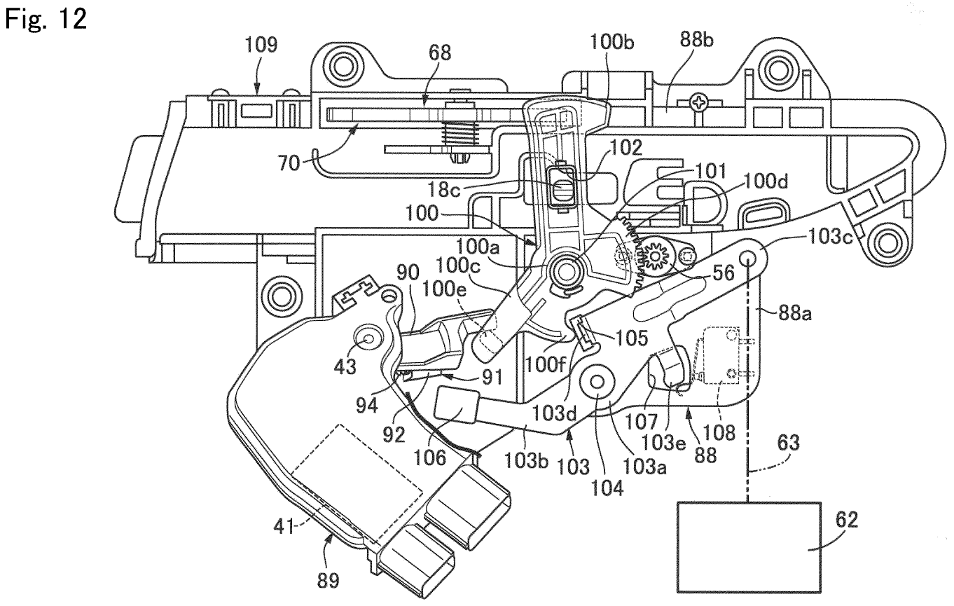

Next, a modified example of the first embodiment will be described with reference to FIGS. 11 and 12. In this modified example, portions corresponding to those of the first embodiment are only illustrated with the same reference signs, and detailed descriptions thereof will be omitted.

First, in FIG. 11, a support case 88 includes a support plate portion 88a and a handle support portion 88b that pivotally supports the outer handle 17 (see the first embodiment), and an actuator 89 is attached to a lower portion of the support plate portion 88a.

The actuator 89 is configured to include a drive lever 90 that is pivotal between the initial position illustrated in FIG. 11 and the operating position illustrated in FIG. 12, and the electric motor 41 that, when energized, pivotally drives the drive lever 90 from the initial position to the operating position, and allows the drive lever 90 to return from the operating position to the initial position in a non-energized state when the drive lever 90 is in the operating position. A base portion of the drive lever 90 is fixed to the pivot shaft 43 that is pivotally driven by the electric motor 41.

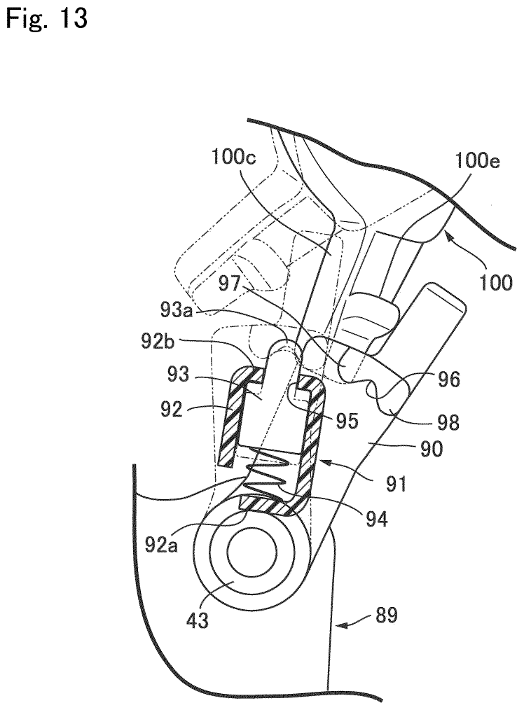

Referring also to FIG. 13, the support plate portion 88a of the support case 88 is provided with a retention means 91 that mechanically holds the drive lever 90 in the operating position so that the retention means 91 is disposed between the drive lever 90 and the support plate portion 88a.

The retention means 91 includes a guide cylinder 92 that is fixed to the support plate portion 88a so as to extend radially from the pivot shaft 43, a movable piece 93 that is slidably fitted in the guide cylinder 92, and a spring 94 that is compressed between the guide cylinder 92 and the movable piece 93.

The guide cylinder 92 is configured to include a first end wall portion 92a at one end portion on the pivot shaft 43 side and a second end wall portion 92b at the other end portion away from the pivot shaft 43, and the spring 94 is provided between the first end wall portion 92a and the movable piece 93. At a center portion of the second end wall portion 92b, a through hole 95 is formed through which an engagement protrusion portion 93a integrally provided with the movable piece 93 can pass.

On the other hand, a surface of the drive lever 90 facing the support plate portion 88a is integrally provided with a locking recessed portion 96 with which the engagement protrusion portion 93a of the retention means 91 can be engaged, and first and second peak portions 97 and 98, which are disposed on both sides of the locking recessed portion 96 and bulge toward the guide cylinder 92. When the drive lever 90 is in the initial position, as illustrated in FIG. 13, the engagement protrusion portion 93a is in a position displaced from the locking recessed portion 96 and the first and second peak portions 97 and 98. When the drive lever 90 pivots from the initial position to the operating position illustrated by a chain line in FIG. 13, the engagement protrusion portion 93a rides over the first peak portion 97 and engages with the locking recessed portion 96, thereby mechanically holding the drive lever 90 in the operating position.

A handle lever 100 is pivotally supported by the support plate portion 88a. The handle lever 100 integrally includes a lever base portion 100a that is pivotally supported by a shaft 101 provided at the support plate portion 88a, an outer handle side coupling arm portion 100b that extends upward from the lever base portion 100a, a drive lever side coupling arm portion 100c that extends obliquely downward from the lever base portion 100a toward the drive lever 90, and a sector gear portion 100d that protrudes from the lever base portion 100a in a direction opposite to the actuator 89.

The outer handle side coupling arm portion 100b is formed with a coupling hole 102 extending long in the longitudinal direction thereof, and the tip portion of the coupling protruding portion 18c of the outer handle 17 is inserted into and coupled to the coupling hole 102, so that the handle lever 100 is interlocked and coupled to the outer handle 17. Moreover, the handle lever 100 is biased by a return spring (not illustrated) in a direction returning the outer handle 17 to the housed position.

An abutment protrusion portion 100e that abuts against the drive lever 90 in the initial position from the operating position side is protrudingly provided integrally at a tip portion of the drive lever side coupling arm portion 100c so as to protrude toward the support plate portion 88a. In response to a pivotal movement of the drive lever 90 from the initial position to the operating position, the abutment protrusion portion 100e is pushed by the drive lever 90, causing the handle lever 100 to pivot so as to drive the outer handle 17 from the housed position to the pop-up position.

Moreover, when the outer handle 17 pivots from the pop-up position to the full stroke position, the drive lever 90 is held by the retention means 91, so that the handle lever 100 pivots together with the outer handle 17, leaving the drive lever 90 in the operating position.

The sector gear portion 100d is meshed with the gear 56 of the rotary damper 55 fastened to the support plate portion 88a.

A release lever 103 is pivotally supported by the support plate portion 88a of the support case 88. The release lever 103 pivots in response to a pivotal movement of the handle lever 100 accompanying manual operation of the outer handle 17 from the pop-up position to the full stroke position, thereby releasing retention by the retention means 91 and forcibly returning the drive lever 90 to the initial position.

The release lever 103 integrally includes a lever base portion 103a that is pivotally supported by the support plate portion 88a via a shaft 104 that is attached to the support plate portion 88a so as to be disposed below the handle lever 100, a drive lever side arm portion 103b that extends from the lever base portion 103a toward the drive lever 90, and a latch mechanism side arm portion 103c that is connected to the lever base portion 103a so as to protrude toward a side opposite to an attachment portion of the actuator 89.

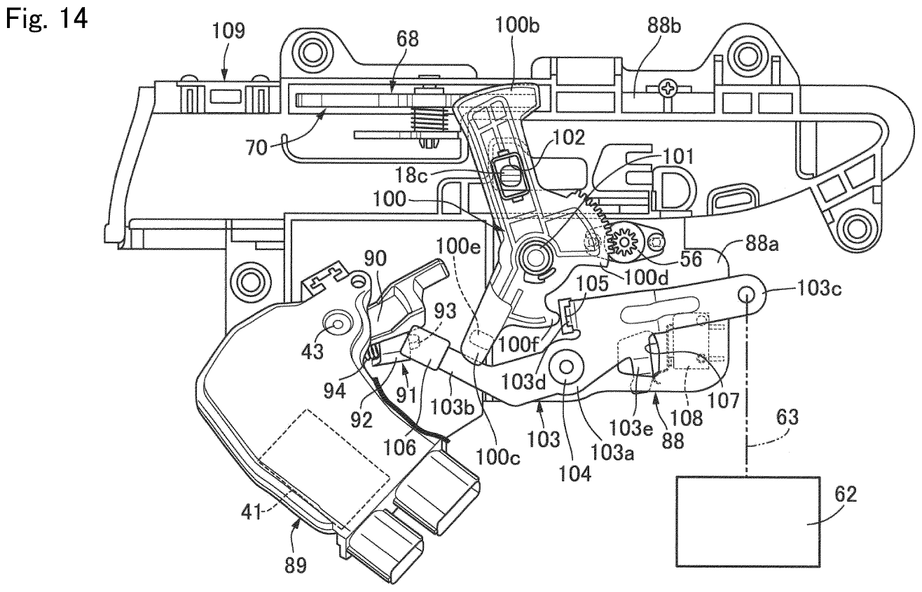

A pressure receiving portion 103d is integrally provided at the latch mechanism side arm portion 103c of the release lever 103 so as to face the drive lever side coupling arm portion 100c of the handle lever 100, and a handle side cap 105 made of an elastic material is attached to the pressure receiving portion 103d. On the other hand, a pushing arm portion 100f is integrally connected to the drive lever side coupling arm portion 100c of the handle lever 100, and when the outer handle 17 pivots from the housed position to the pop-up position, the handle lever 100 pivots together with the outer handle 17 so that a tip portion thereof abuts against the handle side cap 105. When the outer handle 17 pivots from the pop-up position to the full stroke position, the handle lever 100 pivots together with the outer handle 17, causing the pushing arm portion 100f to push the handle side cap 105, that is, the pressure receiving portion 103d, and causing the release lever 103 to pivot to a position illustrated in FIG. 14.

A pivotal movement of the release lever 103 is transmitted to the latch mechanism 62 provided at the side door 15 via the transmission rod 63, one end of which is coupled to a tip portion of the latch mechanism side arm portion 103c.

A drive lever side cap 106 made of an elastic material is attached to a tip portion of the drive lever side arm portion 103b of the release lever 103. The drive lever side cap 106 abuts against a tip portion of the drive lever 90 when the drive lever 90 pivots from the initial position to the operating position. A pivotal movement of the release lever 103 in response to the pivotal movement of the outer handle 17 from the pop-up position to the full stroke position causes the drive lever 90 to be pushed by the drive lever side arm portion 103b of the release lever 103. Thus, the drive lever 90 is pivotally driven forcibly so that the movable piece 93 is pushed by the first peak portion 97 and the engagement protrusion portion 93a rides over the first peak portion 97, thereby returning the drive lever 90 to the initial position.

The release lever 103 is pivotally biased by a spring (not illustrated) in a direction in which the handle side cap 105 abuts against the pushing arm portion 100f of the handle lever 100.

A pressing portion 103e is integrally connected to the latch mechanism side arm portion 103c of the release lever 103, and is inserted into an opening 107 formed at the support plate portion 88a. A switch 108 is attached to a surface of the support plate portion 88a opposite to the side at which the release lever 103 is provided, and the switch 108 changes a switching mode by being pressed by the pressing portion 103e in response to a pivotal movement of the release lever 103 accompanying manual operation of the outer handle 17 from the pop-up position to the full stroke position. When the switch 108 is pressed by the pressing portion 103e to change the switching mode, the switch 108 outputs a signal to open a window of the side door 15 (see the first embodiment) to allow outside air to flow into the vehicle.

The handle support portion 88b of the support case 88 is provided with the inertia mechanism 68 that prevents the outer handle 17 from pivoting to the full stroke position and undesirably opening the side door 15 due to an impact caused by a side collision with the side door 15 when the outer handle 17 is in the housed position. Also, a light 109 is attached to illuminate the operating portion 18a (see the first embodiment) of the outer handle 17 when the outer handle 17 is in the pop-up position.

According to the modified example of the first embodiment described above, similar effects to those of the first embodiment can be achieved, and in addition, in response to the pivotal movement of the release lever 103 accompanying manual operation of the outer handle 17 from the pop-up position to the full stroke position, the window of the side door 15 is opened and outside air flows into the vehicle, thereby reducing an air pressure difference between the inside and outside of the side door 15 and facilitating the opening operation of the side door 15.

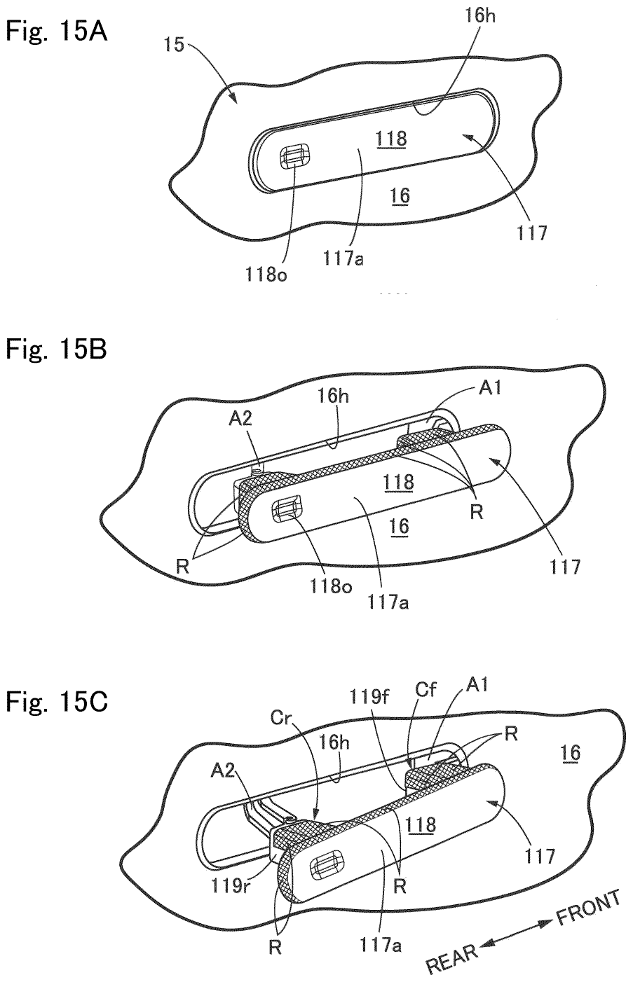

Next, a second embodiment of the present invention will be described with reference to FIGS. 15A to 22. Note that in the description of the second embodiment, front, rear, left, and right correspond to front, rear, left, and right of a vehicle to which a side door 15 is attached, respectively.

First, in FIGS. 15A to 15C, an outer panel 16 of the side door 15 of a passenger vehicle is provided with an outer handle 117 that is formed long in a vehicle longitudinal direction facing a handle hole 16h having a decorative border thereon. The outer handle 117 can be changed in position between a housed position where an outer surface of the outer panel 16 is flush with an outer surface of the outer handle 117, as illustrated in FIGS. 15A to 15C, a pop-up position where main parts including an operating portion 117a for manual operation protrude laterally from the outer surface of the outer panel 16, as illustrated in FIG. 15B, and a full stroke position where the main parts are pivoted further outward from the pop-up position by grasping and operating the operating portion 117a, as illustrated in FIG. 15C.

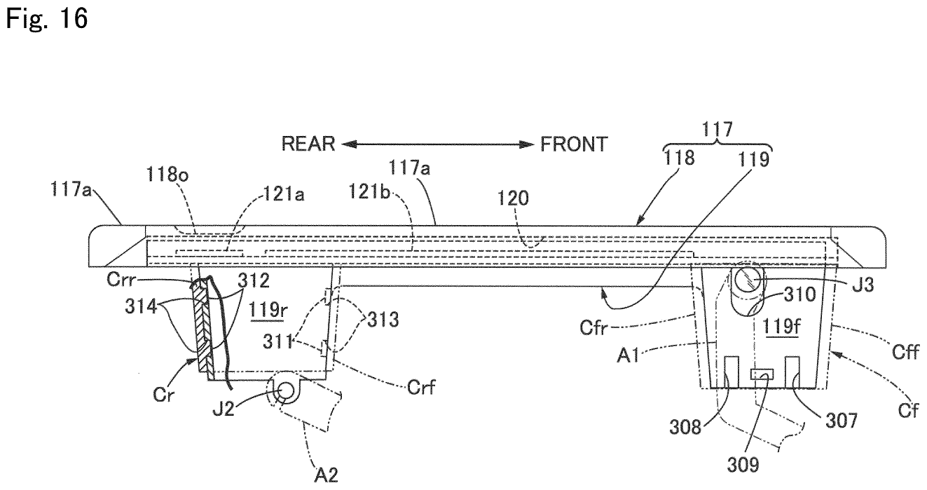

Referring also to FIG. 16, the outer handle 117 is composed of a handle body 118 that extends long in the vehicle longitudinal direction and includes a recessed portion 120 facing an inner side of the outer panel 16, and a handle base 119 that is long in the longitudinal direction and detachably coupled to the handle body 118 from the outer panel 16 side so as to close the recessed portion 120. The handle body 118 and the handle base 119 may be coupled to each other by a locking/unlocking means (e.g., elastic locking claws and locking holes that can be locked thereto and unlocked therefrom) (not illustrated) provided therebetween, or may be coupled to each other by using multiple bolts (not illustrated).

A portion of the outer handle 117 that can be grasped by the vehicle user's hand when the outer handle 117 is in the pop-up position (i.e., a portion on which fingers of the user's hand are placed when performing a full stroke operation from the pop-up position) serves as the operating portion 117a. To be more specific, a portion of the outer handle 117 that is located between front and rear bulge portions 119f and 119r described later and extends in the longitudinal direction, and a portion on the rear side of the rear bulge portion 119r function as the operating portion 117a.

A touch sensor 121a for indicating an intention to lock or unlock the side door 15, and a substrate 121b incorporating an antenna and an electronic control device are attached to an inner surface of the handle base 119 (i.e., a recessed surface facing the handle body 118). The touch sensor 121a is composed of, for example, a non-contact sensor capable of detecting changes in capacitance. A shallow recess 118o is provided at an outer surface of the handle body 118 near the rear end at a position corresponding to the touch sensor 121a. When the vehicle user's hand touches the recess 118o, the locking or unlocking operation of the latch mechanism 62 and the pop-up operation of the outer handle 117 can be performed approximately at the same time, as described later.

For example, when the substrate 121b confirms that a vehicle user is an authorized user through communication between the vehicle and a portable device carried by the vehicle user within a predetermined range from the vehicle, and the user's hand touches the recess 118o, the touch sensor 121a outputs a detection signal to the substrate 121b based on a change in the surrounding capacitance, and in response, the substrate 121b operates an actuator 139 to extend the outer handle 117, which is in the housed position, to the pop-up position.

A pair of front and rear bulge portions 119f and 119r that are protrudingly provided toward the inside of the outer panel 16 are protrudingly provided integrally at a rear surface of the handle base 119 (i.e., a surface opposite to the handle body 118). The bulge portions 119f and 119r are both formed in a rectangular cylindrical shape that tapers slightly as a distance from the handle body 118 increases. Front and rear covers Cf and Cr that cover upper surfaces of the front and rear bulge portions 119f and 119r are detachably attached to the front and rear bulge portions 119f and 119r, respectively, and structures for fixing the front and rear covers Cf and Cr to the front and rear bulge portions 119f and 119r will be described later.

The outer handle 117 is attached to a support case 122 that is fixed to the outer panel 16 so as to be movable between the housed position (see FIG. 15A), the pop-up position (see FIG. 15B), and the full stroke position (see FIG. 15C). That is, between the outer handle 117 and the support case 122, a drive device D that can drive the outer handle 117 from the housed position to the pop-up position and a guide device G that guides a manual pivotal operation of the outer handle 117 from the pop-up position to the full stroke position are interposed.

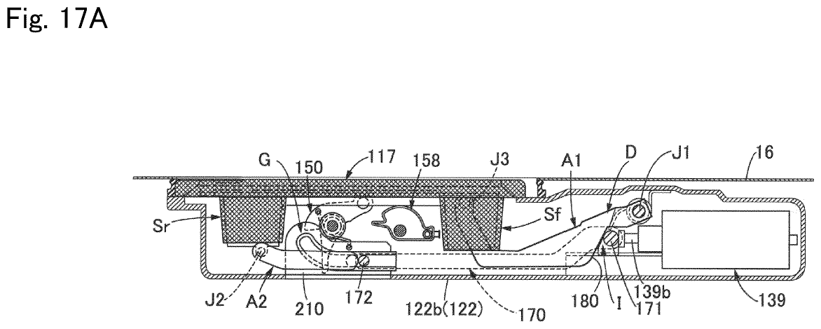

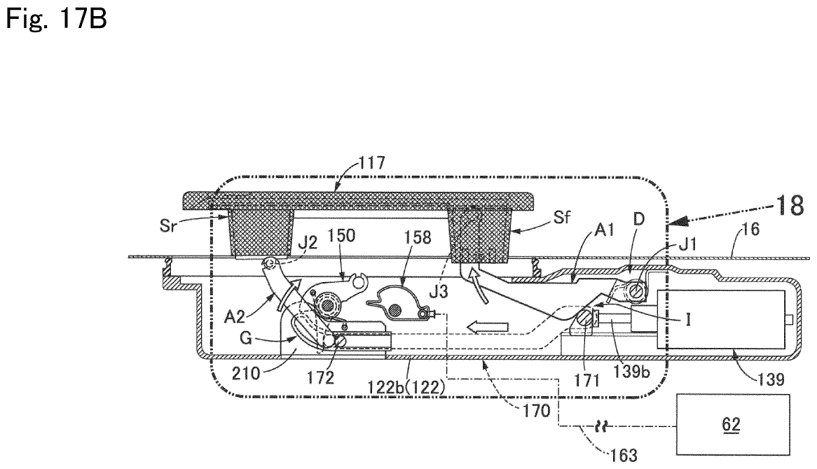

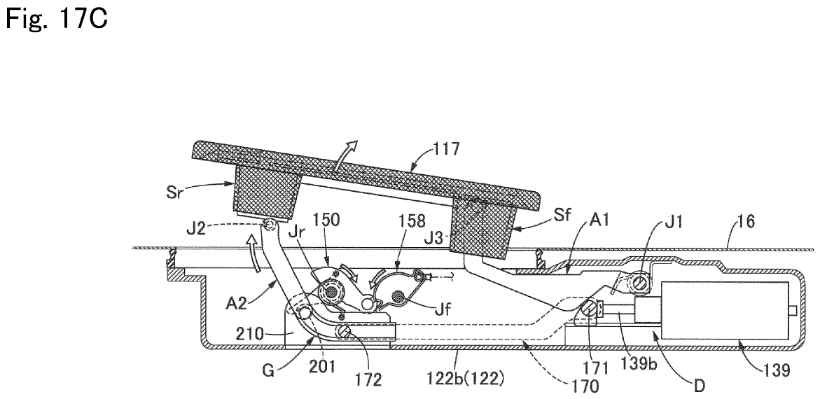

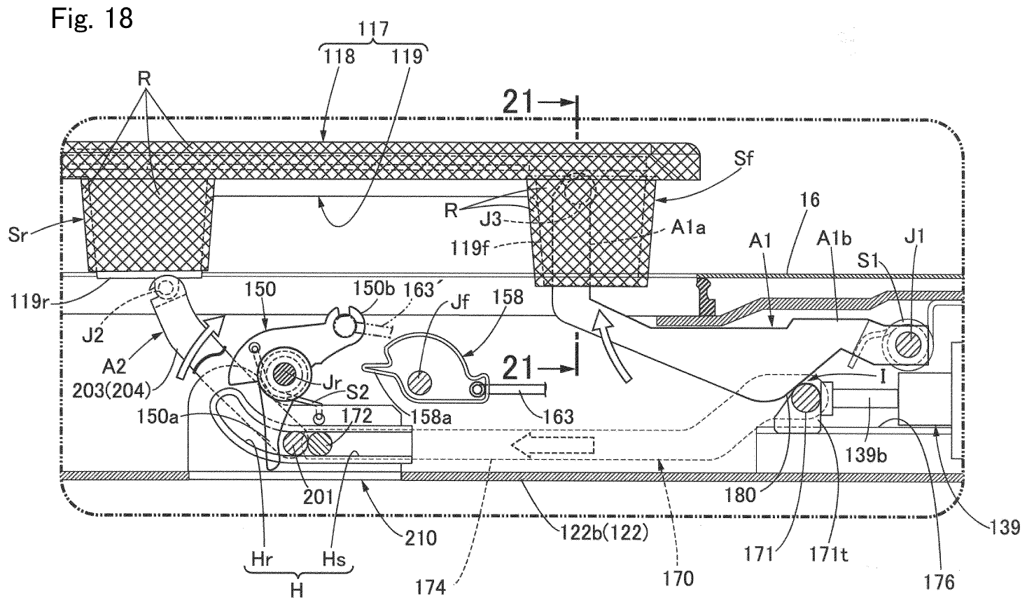

The support case 122 is composed of two parts, a pair of upper and lower case halves 122a and 122b, which are detachably coupled to each other at respective opening ends thereof via coupling means (e.g., bolts) (not illustrated), and only the lower case half 122b is illustrated in FIGS. 17A to 17C and 18.

The drive device D includes the support case 122, the actuator 139 (e.g., an electric motor) including a rearward-facing output bar 139b and being housed and fixed to a front portion of the support case 122, a first arm A1 supported by a base end portion A1b thereof so as to swing left and right about a first shaft J1 bridged between the upper and lower case halves 122a and 122b, a second arm A2 pivotally coupled to a tip portion of the rear bulge portion 119r of the handle base 119 via a second shaft J2 at a base end portion thereof (rear end portions of upper and lower coupling rods 203 and 204 described later) so as to be capable of a relative pivotal movement, and an interlocking mechanism I that interlocks the first and second arms A1 and A2 with an output movement (rearward movement) of the output bar 139b to cause the outer handle 117 to extend from the housed position to the pop-up position.

A tip portion A1a of the first arm A1 is pivotally coupled to a base portion of the front bulge portion 119f of the handle base 119 via a third shaft J3 as a pivot shaft so as to be capable of a relative pivotal movement. A first return spring S1 (e.g., a torsion coil spring) is interposed between the first arm A1 and the support case 122 to constantly bias the first arm A1 inward (toward the vehicle compartment), that is, toward the housed position.

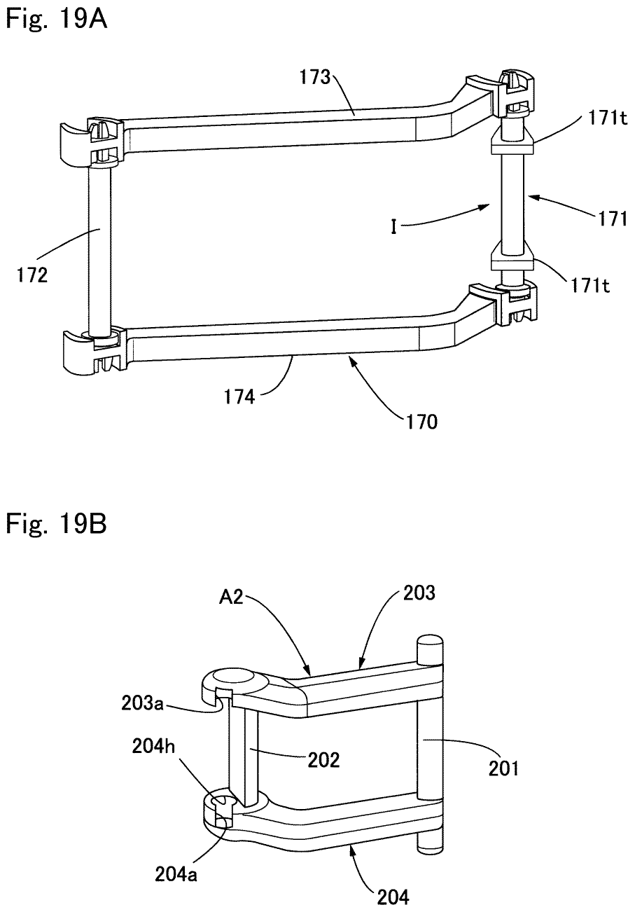

As is apparent from FIGS. 18 and 19B, the second arm A2 is composed of a rectangular frame in which front and rear coupling shafts 201 and 202, each of which extends in the vertical direction, and the upper and lower coupling rods 203 and 204 are integrally coupled to each other. The front coupling shaft 201 is formed in a shaft shape, and an intermediate portion thereof is slidably fitted into and supported by a guide member 210 (to be specific, a guide hole H provided at the guide member 210) fixed to a bottom portion of the support case 122. The guide hole H has a straight hole portion Hs on a front half side extending in the longitudinal direction and a curved hole portion Hr on a rear half side that is continuous with a rear end of the straight hole portion Hs and curved rearward and outward.

As is apparent from FIG. 18, the interlocking mechanism I includes a transmission frame 170 extending in the longitudinal direction between a tip portion of the output bar 139b of the actuator 139 and the front coupling shaft 201 of the second arm A2 so as to connect the tip portion of the output bar 139b of the actuator 139 and the front coupling shaft 201 of the second arm A2, and a cam surface 180 formed on an inner surface of an intermediate portion of the first arm A1 and inclined forward and outward.

The cam surface 180 faces the output bar 139b with the front transmission shaft 171 of the transmission frame 170 (described later) interposed therebetween, and the cam surface 180 and the front transmission shaft 171 in sliding contact therewith constitute a cam mechanism that converts the rearward movement of the output bar 139b into outward swinging movement of the first arm A1 about the first shaft J1.

Thus, as is apparent from FIGS. 18 and 19A, the transmission frame 170 is composed of a rectangular frame that is long in the longitudinal direction and is formed by pivotally coupling adjacent ends of the vertically extending front and rear transmission shafts 171 and 172, each of which extends in the vertical direction, and upper and lower links 173 and 174, each of which is located outside the support case 122 and extends long in the longitudinal direction.

Upper and lower end portions of the front transmission shaft 171 extend outside the support case 122 through front openings (not illustrated) of the upper and lower case halves 122a and 122b, and front end portions of the upper and lower links 173 and 174 are detachably fitted and coupled to the extended end portions of the front transmission shaft 171. On peripheries of intermediate portions near the upper and lower ends of the front transmission shaft 171, a pair of upper and lower guide protrusions 171t are protrudingly provided integrally, which are engaged with and supported by guide rails 176 provided at inner walls of the upper and lower case halves 122a and 122b so as to be relatively movable (slidable) only in the longitudinal direction.

On the other hand, upper and lower end portions of the rear transmission shaft 172 extend outside the support case 122 through rear openings (not illustrated) of the upper and lower case halves 122a and 122b, and rear end portions of the upper and lower links 173 and 174 are detachably fitted and coupled to the extended end portions of the rear transmission shaft 172. An intermediate portion of the rear transmission shaft 172 passes through and is supported by the rear openings of the upper and lower case halves 122a and 122b and the guide hole H (particularly, the straight hole portion Hs) of the guide member 210 described above so as to be slidable in the longitudinal direction.

Thus, as is apparent from FIGS. 17A to 17C and 18, when the outer handle 117 is in the housed position or just before the pop-up position, the periphery of the intermediate portion of the rear transmission shaft 172 is in movably contact with the front coupling shaft 201 of the second arm A2 in the straight hole portion Hs, and in this state, the driving force of the actuator 139 can be transmitted to the front coupling shaft 201 through the transmission frame 170.

Therefore, for example, when the actuator 139 is actuated while the outer handle 117 is in the housed position, and the driving force of the actuator 139 moves the transmission frame 170 (thus the rear transmission shaft 172 and the front coupling shaft 201) rearward, the second arm A2 swings outward about an axis of the front coupling shaft 201, and at the same time, the front transmission shaft 171 of the transmission frame 170 pushes the cam surface 180 while sliding against the cam surface 180, causing the first arm A1 to swing outward about the first shaft J1.

Then, due to the above-mentioned outward swings of the first and second arms A1 and A2 (see white arrows in FIG. 17B), the outer handle 117 is extended and held in the pop-up position while keeping the outer surface thereof approximately parallel to the outer panel 16.

When the outer handle 117 is in the pop-up position and the vehicle user attempts to pivotally operate the outer handle 117 to the full stroke position by, for example, placing his/her hand on the operating portion 117a of the outer handle 117, the front coupling shaft 201 is guided and slid outward within the curved hole portion Hr so as to move away from the rear transmission shaft 172, and at the same time, the outer handle 117 swings outward about the third shaft J3 (see a white arrow in FIG. 17C) to move to the full stroke position.

Thus, the guide hole H with the curved hole portion Hr, the second arm A2, and the third shaft J3 cooperate with each other to constitute the guide device G.

As is apparent from FIG. 18, front and rear lever shafts Jf and Jr are bridged between the upper and lower case halves 122a and 122b around the guide hole H of the guide member 210 so as to be spaced apart from each other in the longitudinal direction. A relay lever 150 is pivotally supported by the rear lever shaft Jr, of the front and rear lever shafts Jf and Jr. The relay lever 150 integrally includes a first arm portion 150a that can be detachably engaged with a periphery (particularly, a rear surface side) of an intermediate portion of the front coupling shaft 201 of the second arm portion A2, and a second arm portion 150b that can be locked to and unlocked from a locking protrusion portion 158a at a rear portion of a release lever 158, which will be described next.

In particular, the first arm portion 150a is inserted into an internal space of the second arm A2 so as to be able to engage with the front coupling shaft 201 of the second arm A2. A second return spring S2, which is a torsion coil spring, is interposed between the relay lever 150 and the guide member 210. The second return spring S2 constantly biases the relay lever 150 in a direction in which the first arm portion 150a engages with the second arm A2 (to be specific, the front coupling shaft 201), that is, in the counterclockwise direction in FIG. 18.

The release lever 158 is pivotally supported on the front lever shaft Jf, and the release lever 158 is interlocked and coupled with a latch mechanism 62 in the side door 15 via a transmission rod 163. Note that the latch mechanism 62 of the second embodiment has the same structure and functions as the latch mechanism 62 of the first embodiment, so the same reference sign is used and further functional description is omitted.

Thus, in the second embodiment, the transmission rod 163 connected to the latch mechanism 62 is interlocked with the relay lever 150 via the release lever 158. However, depending on the arrangement of the latch mechanism 62, the release lever 158 may be omitted and a transmission rod 163′ connected to the latch mechanism 62 may be directly coupled to the second arm portion 150b of the relay lever 150, as illustrated by a two-dot chain line in FIG. 18.

In the second embodiment, the latch mechanism 62 is unlocked in response to a detection of contact of an authorized vehicle user's hand with the outer handle 117 (to be specific, the recess 118o) by the touch sensor 121a and the substrate 121b in the outer handle 117 while the latch mechanism 62 is in the locked state. At approximately the same time, the actuator 139 operates to swing the first arm A1 outward about the first shaft J1 and the second arm A2 outward about the axis of the front coupling shaft 201, thereby displacing the outer handle 117 outward from the housed position to the pop-up position (see FIG. 17B). In this case, when the outer handle 117 is displaced to the pop-up position, the first arm A1 engages with an inner wall of the support case 122, thereby restricting further outward swing.

In this state, when the vehicle user places his/her hand on the operating portion 117a of the outer handle 117 and attempts to pull out the outer handle 117 from the pop-up position to the full stroke position, the operation force causes the outer handle 117 to swing outward about the third shaft J3 and move to the full stroke position. During this time, the front coupling shaft 201 of the second arm A2 moves outward while being slidably guided by the curved hole portion Hr of the guide hole H, whereby the second arm A2 swings upright about the axis of the front coupling shaft 201 while being displaced further outward than when in the pop-up position.

In this case, as is apparent from FIG. 17C, since the first arm portion 150a of the relay lever 150 is engaged with the front coupling shaft 201, the relay lever 150 pivots clockwise (FIGS. 17A to 17C) about the rear lever shaft Jr in conjunction with the outward movement of the front coupling shaft 201 along the curved hole portion Hr. Accordingly, the second arm portion 150b of the relay lever 150 engages with the locking protrusion portion 158a of the release lever 158, causing the release lever 158 to pivot counterclockwise (FIGS. 17A to 17C) about the front lever shaft Jf, thereby operating the transmission rod 163 in the unlatching direction in the latch mechanism 62.

Thus, the manual operation force applied to the outer handle 117 from the pop-up position to the full stroke position is transmitted sequentially through the second arm A2, the relay lever 150, the release lever 158, and the transmission rod 163 to the latch mechanism 62, causing the latch mechanism 62 to be unlatched, making it possible to open the side door 15.

As described above, the front and rear covers Cf and Cr are detachably attached to the upper surfaces of the pair of protruding front and rear bulge portions 119f and 119r of the handle base 119, and the fixing structures of the front and rear covers Cf and Cr to the front and rear bulge portions 119f and 119r will be described below with reference to FIGS. 16 to 22.

The front and rear covers Cf and Cr each include trapezoidal flat cover bodies Cfm and Crm that are placed on and overlap the flat upper surfaces of the front and rear bulge portions 119f and 119r, and pairs of front and rear support pieces Cff and Cfr, and Crf and Crr that are integrally connected to front and rear end edge portions of the cover bodies Cfm and Crm and cover the upper portions of the front and rear side surfaces of the front and rear bulge portions 119f and 119r, respectively. The pairs of front and rear support pieces Cff and Cfr, and Crf and Crr are smoothly curved and protrude downward from the front and rear end edge portions of the cover bodies Cfm and Crm, and engage with the corresponding front and rear bulge portions 119f and 119r so as to sandwich the upper portions thereof from the front and rear.

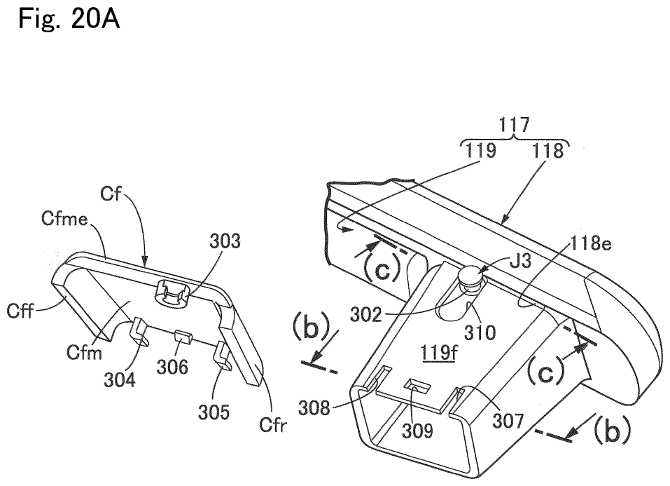

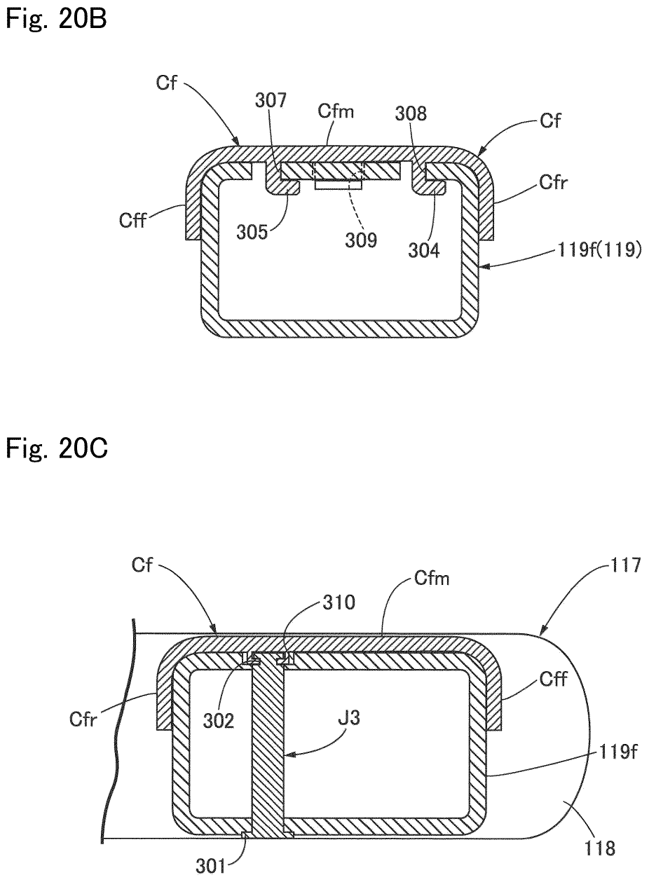

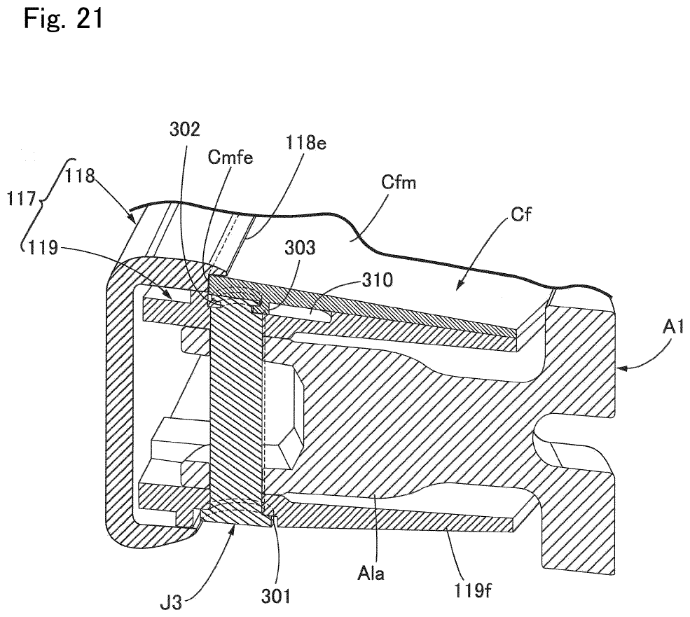

As is apparent from FIGS. 20A to 20C, and 21, the third shaft J3 is inserted upward from below into a base portion of the front bulge portion 119f, and the third shaft J3 includes an outward-facing flange portion 301 at a peripheral lower end portion thereof and an annular engagement groove 302 at a peripheral upper end portion thereof. The outward-facing flange portion 301 engages with a lower wall of the front bulge portion 119f, and defines a rising limit of the third shaft J3 relative to the front bulge portion 119f.

On the other hand, on a lower surface of the cover body Cfm of the front cover Cf, as is apparent from FIGS. 20A to 20C, and 21, a semi-cylindrical engagement portion 303 is protrudingly provided integrally at an end portion closer to the handle body 118. The semi-cylindrical engagement portion 303 engages with the engagement groove 302 to prevent the third shaft J3 from coming off the outer handle 117 (to be specific, the front bulge portion 119f). On the lower surface of the cover body Cfm, a pair of front and rear engagement protrusions 304 and 305 and a single engagement claw 306 located between the engagement protrusions 304 and 305 are protrudingly provided integrally at the end portion opposite to the handle body 118. On an upper surface of the cover body Cfm, a long hole-shaped recessed surface 310 that slidably receives the engagement portion 303 is provided.

Thus, during a process of assembling the front cover Cf, the front cover Cf is placed on the upper surface of the front bulge portion 119f and slid toward the handle body 118, so that, as is apparent from FIG. 21, a front end edge portion Cmfe of the cover body Cfm in the sliding direction is engaged so as to slip into a side edge 118e of the handle body 118, and the engagement portion 303 is engaged with the engagement groove 302 of the third shaft J3 serving as the pivot shaft.

At approximately the same time, the pair of front and rear engagement protrusions 304 and 305 are respectively engaged with a pair of front and rear notched locking holes 307 and 308 provided at an upper wall of a tip portion of the front bulge portion 119f, and the engagement claw 306 is engaged with a claw locking hole 309 provided at the upper wall of the tip portion of the front bulge portion 119f.

Thus, the front cover Cf can be locked to and unlocked from the upper surface of the front bulge portion 119f, and the front cover Cf (to be specific, the engagement portion 303) can prevent the third shaft J3 from coming off the outer handle 117.

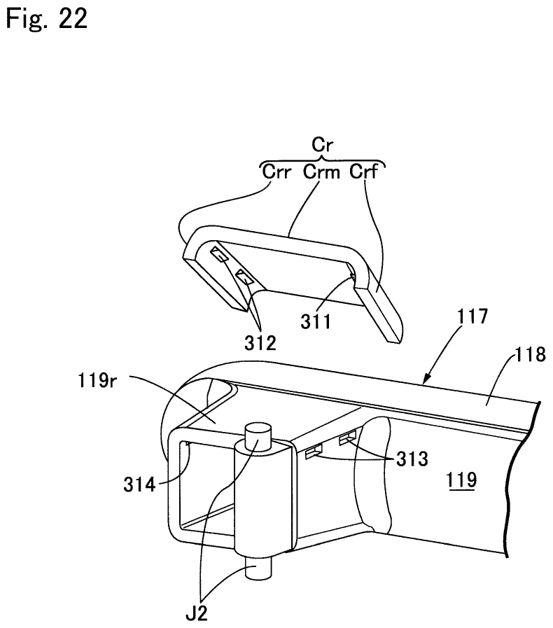

On the other hand, as is apparent from FIGS. 16 and 22, multiple inward locking protrusions 311 and 312 are protrudingly provided at facing surfaces of the pair of front and rear support pieces Crf and Crr of the rear cover Cr, respectively. Corresponding to the locking protrusions 311 and 312, engagement holes 313 and 314 that can be locked/unlocked by the locking protrusions 311 and 312 are provided at upper portions of front and rear side walls of the rear bulge portion 119r.

Therefore, by pushing the rear cover Cr down so as to cover the rear bulge portion 119r from above, the front and rear support pieces Crf and Crr can be elastically deformed to spread apart, and the locking protrusions 311 and 312 can be locked into the engagement holes 313 and 314, respectively. By this locking, the rear cover Cr is detachably fixed to the rear bulge portion 119r.

As described above, in the second embodiment, the front and rear covers Cf and Cr are detachably attached to the upper surfaces of the handle body 118 and the front and rear bulge portions 119f and 119r of the handle base 119 of the outer handle 117 that are exposed to the outside in the pop-up position, and cover at least part of the upper surfaces (the entire surface in the illustrated example). Thus, even when the front and rear covers Cf and Cr are not specially provided with a light reflecting surface R, which will be described later, for example, the front and rear covers Cf and Cr may be colored differently from a paint color of the outer surface of the outer handle 117 or may be plated to provide variety. Not only that, the front and rear covers Cf and Cr can be replaced easily and easily adapted to a preference of the vehicle user.

As is apparent from FIGS. 15A to 15C, 17, and 18, on the upper surface, the rear surface, and the front surface of the outer handle 117 that are exposed to the outside in the pop-up position, the light reflecting surface R (indicated by cross-hatching in FIGS. 15A to 15C, 17, and 18 to clearly indicate a reflective surface area) is provided that shines by reflecting external light (e.g., lights of other vehicles, street lights, etc.). However, in FIGS. 16 and 20 to 22, in order to make it easier to clarify the relative structure of the outer handle 117, in particular, the handle body 118 and the handle base 119, the light reflecting surface R that is actually provided is not illustrated by the hatching.

Thus, the light reflecting surface R is provided at the outer handle 117, for example, by attaching a light reflecting sheet or a light reflecting tape to the upper surface, the rear surface, and the front surface of the handle body 18 and the upper surfaces, the rear surfaces, and the front surfaces of the front and rear covers Cf and Cr or by painting the upper surface, the rear surface, and the front surface of the handle body 18 and the upper surfaces, the rear surfaces, and the front surfaces of the front and rear covers Cf and Cr with a light reflecting paint.

Thus, also in the second embodiment, the light reflecting surface R is provided at at least part of the rear surface of the end portion on the vehicle rear side and the upper surface of the outer handle 117 (in the illustrated example, the entire upper surface, the rear surface, and the front surface) among the exposed surfaces that are exposed to the outside in the pop-up position. Accordingly, the second embodiment can achieve a similar effect as the effect achieved by the light reflecting surface R in the first embodiment. That is, even when the outer handle 117 protrudes outward from the outer surface of the outer panel 16 to some extent in the pop-up position, people, vehicle drivers, or the like moving around the side door 15 in situations where visibility is reduced, such as at night, can easily notice the presence of the outer handle 117 in the pop-up position by the reflected light from the light reflecting surface R, and thus contact with the outer handle 117 can be effectively avoided.

Further, in the second embodiment, the light reflecting surface R is provided not only on the upper surface, the rear surface, and the front surface of the handle body 118 but also on the upper surfaces, the rear surfaces, and the front surfaces of the front and rear covers Cf and Cr. This has an advantage that the variety of the light reflecting surface R to be provided at the outer handle 117 can be increased easily and at low cost also by special provision of the light reflecting surface R on the front and rear covers Cf and Cr.

The embodiments of the present invention and the modified example thereof have been described above. However, the present invention is not limited to the above embodiments, and various design changes can be made without departing from the present invention described in the claims.

For example, in the first and second embodiments, the electric motor is used as the electric drive source of the actuators 39, 89, and 139 used to drive the outer handles 17 and 117 from the housed position to the pop-up position. However, the electric drive source for the actuator is not limited to the embodiments, and electromagnetic drive means other than the electric motor (e.g., a solenoid) may be used.

In the second embodiment, the example is described in which the locking or unlocking operation of the latch mechanism 62 and the pop-up operation of the outer handle 117 can be performed approximately at the same time by touching the recess 118o of the outer handle 117 with the hand of the vehicle user carrying the authentication portable device. However, the locking/unlocking operation and the pop-up operation may be operated by separate operation buttons.

In the first and second embodiments, the example is described in which the light reflecting surface R is provided at the upper surfaces and the rear surfaces (and also at the front surface in the second embodiment) of the outer handles 17 and 117 that are exposed to the outside in the pop-up position. However, the light reflecting surface R may be provided at only either the upper surfaces or the rear surfaces (e.g., the rear surfaces) of the outer handles 17 and 117 that are exposed to the outside in the pop-up position. Alternatively, the light reflecting surface R may be provided at only at least part of the upper surfaces and/or at least part of the rear surfaces of the outer handle 17 and 117 that are exposed to the outside in the pop-up position.

In particular, in the second embodiment, the example is described in which the light reflecting surface R is provided not only at the upper surface, the rear surface, and the front surface of the handle body 118 of the outer handle 117 but also at the upper surface, the rear surface and the front surface of each of the front and rear covers Cf and Cr that cover the upper surface of the handle base 119 (in particular, the front and rear bulge portions 119f and 119r). However, in the present invention, the light reflecting surface R may be provided at only either the upper surface or the rear surface (e.g., the rear surface) of each of the front and rear covers Cf and Cr. Alternatively, the light reflecting surface R may be provided at only one of the front cover Cf and the rear cover Cr (e.g., the rear cover Cr), or the provision of the light reflecting surface R may be omitted from the front and rear covers Cf and Cr.

In the first and second embodiments, the light reflecting surfaces R provided at the outer handles 17 and 117 reflect only the external light, but a lighting device (e.g., an LED) that illuminates the light reflecting surface R from the outside or the inside may be attached to the outer handles 17 and 117. In this case, the visibility of the light reflecting surface R can be further improved by the light of the lighting device.

What is claimed is:

1. An outer handle device for a vehicle door, comprising:
an outer handle (17, 117) including an operating portion (18a, 117a) configured to be manually operated, and being attached to a support case (22, 88, 122) fixed to an outer panel (16) of a door (15) so as to be movable between a housed position where an outer surface of the outer handle (17, 117) is substantially flush with an outer surface of the outer panel (16) and a pop-up position where the operating portion (18a, 117a) protrudes outward from the outer panel (16); and
an actuator (39, 89, 139) configured to drive the outer handle (17, 117) from the housed position to the pop-up position,
wherein the outer handle (17, 117) is attached to the support case (22, 88, 122) so that the outer handle (17, 117) is fully stroked manually from the pop-up position to a full stroke position further outward, and
a light reflecting surface (R) is provided at at least part of a rear surface of an end portion at least on a vehicle rear side among exposed surfaces of the outer handle (17, 117) that are exposed to an outside in the pop-up position.

2. An outer handle device for a vehicle door, comprising:
an outer handle (17, 117) including an operating portion (18a, 117a) configured to be manually operated, and being attached to a support case (22, 88, 122) fixed to an outer panel (16) of a door (15) so as to be movable between a housed position where an outer surface of the outer handle (17, 117) is substantially flush with an outer surface of the outer panel (16) and a pop-up position where the operating portion (18a, 117a) protrudes outward from the outer panel (16); and
an actuator (39, 89, 139) configured to drive the outer handle (17, 117) from the housed position to the pop-up position,
wherein the outer handle (17, 117) is attached to the support case (22, 88, 122) so that the outer handle (17, 117) is fully stroked manually from the pop-up position to a full stroke position further outward, and
a light reflecting surface (R) is provided at at least part of an upper surface, of the outer handle (17, 117), that is exposed to an outside in the pop-up position.

3. The outer handle device for a vehicle door, according to claim 1, wherein, on the upper surface, of the outer handle (117), that is exposed to the outside in the pop-up position, at least one cover (Cf, Cr) configured to cover at least part of the upper surface is detachably attached, and the light reflecting surface (R) is provided at at least a rear surface of the at least one cover (Cf, Cr).

4. The outer handle device for a vehicle door, according to claim 2, wherein, on the upper surface, of the outer handle (117), that is exposed to the outside in the pop-up position, at least one cover (Cf, Cr) configured to cover at least part of the upper surface is detachably attached, and the light reflecting surface (R) is provided at at least a rear surface of the at least one cover (Cf, Cr).

5. The outer handle device for a vehicle door, according to claim 1, wherein a pivot shaft (J3) configured to guide and support a pivotal movement of the outer handle (117) is fitted with the outer handle (117) when the outer handle (117) is pivotally operated from the pop-up position to the full stroke position, and one of the at least one cover (Cf) is provided with an engagement portion (303) configured to engage with the pivot shaft (J3) to prevent the pivot shaft (J3) from coming off the outer handle (117).

6. The outer handle device for a vehicle door, according to claim 2, wherein a pivot shaft (J3) configured to guide and support a pivotal movement of the outer handle (117) is fitted with the outer handle (117) when the outer handle (117) is pivotally operated from the pop-up position to the full stroke position, and one of the at least one cover (Cf) is provided with an engagement portion (303) configured to engage with the pivot shaft (J3) to prevent the pivot shaft (J3) from coming off the outer handle (117).

7. The outer handle device for a vehicle door, according to claim 1, wherein the outer handle (17, 117) is provided with a lighting device configured to illuminate the light reflecting surface (R).

8. The outer handle device for a vehicle door, according to claim 2, wherein the outer handle (17, 117) is provided with a lighting device configured to illuminate the light reflecting surface (R).
